(19) United States
(12) Patent Application Publication
(10) Pub. No.: US 2026/0095223 A1
(43) Pub. Date: Apr. 2, 2026

(54) REDUCED NON-ZERO COEFFICIENT SELECTION BITMAP FOR TIME DOMAIN CHANNEL STATUS INFORMATION

(71) Applicant: QUALCOMM Incorporated, San Diego, CA (US)

(72) Inventors: Liangming WU, Beijing (CN); Jing DAI, Beijing (CN); Wei XI, Beijing (CN)

(21) Appl. No.: 19/111,670

(22) PCT Filed: Nov. 4, 2022
(86) PCT No.: PCT/CN2022/129776

§ 371 Date: Mar. 13, 2025

(51) Int. Cl. H04B 7/06; H04W 72/044; H04W 72/21

(52) U.S. Cl. CPC H04B 7/0626; H04W 72/044; H04W 72/21

(57) ABSTRACT

A UE measures multiple occasions of CSI-RS. The UE also transmits, at a first stage, a first coefficient selection bitmap for CSI based on measurement of the CSI-RS and associated with a first domain and a second domain, first the coefficient selection bitmap indicating locations of NZCs. In one aspect, the UE further transmits, at a second stage, a second coefficient selection bitmap indicating, for each NZC location indicated in the first coefficient selection bitmap, a corresponding NZC location in a time domain. In another aspect, the UE further transmits, at a second stage, a second coefficient selection bitmap indicating, for each subset in each time domain basis of a three-dimensional bitmap and that is associated with one of a first domain or a second domain, whether an NZC is located in the subset.

### TECHNICAL FIELD

The present disclosure relates generally to communication systems, and more particularly, to wireless communication including selection bitmaps for time domain channel status information.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus may include memory; and at least one processor coupled to the memory and configured to: measure multiple occasions of a channel state information reference signal (CSI-RS); transmit, at a first stage, a first coefficient selection bitmap for channel state information (CSI) based on measurement of the CSI-RS and associated with a first domain and a second domain, the first coefficient selection bitmap indicating locations of non-zero coefficients (NZCs); and transmit, at a second stage, a second coefficient selection bitmap indicating, for each NZC location indicated in the first coefficient selection bitmap, a corresponding NZC location in a time domain.

In an aspect of the disclosure, a method, a computer-readable medium, and an apparatus are provided for wireless communication at a user equipment (UE). The apparatus may include memory; and at least one processor coupled to the memory and configured to: measure multiple occasions of a channel state information reference signal (CSI-RS); transmit, at a first stage, a first coefficient selection bitmap for channel state information (CSI) based on measurement of the CSI-RS and associated with a first domain and a second domain, the first coefficient selection bitmap indicating locations of non-zero coefficients (NZCs); and transmit, at a second stage, a second coefficient selection bitmap indicating, for each subset in each time domain basis of a three-dimensional bitmap and that is associated with one of a first domain or a second domain, whether an NZC is located in the subset.

In an aspect of the disclosure, a method, a computer-readable medium, and an apparatus are provided for wireless communication at a network node. The apparatus may include memory; and at least one processor coupled to the memory and configured to: provide multiple occasions of a channel state information reference signal (CSI-RS); obtain, at a first stage, a first coefficient selection bitmap for channel state information (CSI) based on measurement of the CSI-RS and associated with a first domain and a second domain, the first coefficient selection bitmap indicating locations of non-zero coefficients (NZCs); and obtain, at a second stage, a second coefficient selection bitmap indicating, for each NZC location indicated in the first coefficient selection bitmap, a corresponding NZC location in a time domain.

In an aspect of the disclosure, a method, a computer-readable medium, and an apparatus are provided for wireless communication at a user equipment (UE). The apparatus may include memory; and at least one processor coupled to the memory and configured to: provide multiple occasions of a channel state information reference signal (CSI-RS); obtain, at a first stage, a first coefficient selection bitmap for channel state information (CSI) based on measurement of the CSI-RS and associated with a first domain and a second domain, the first coefficient selection bitmap indicating locations of non-zero coefficients (NZCs); and obtain, at a second stage, a second coefficient selection bitmap indicating, for each subset in each time domain basis of a three-dimensional bitmap and that is associated with one of a first domain or a second domain, whether an NZC is located in the subset.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an enhanced Type II codebook, in accordance with various aspects of the present disclosure.

FIG. 5 is a diagram illustrating an example of a two-part channel status information (CSI), in accordance with various aspects of the present disclosure.

FIG. 6 is a diagram illustrating time domain (TD) compression in accordance with various aspects of the present disclosure.

FIG. 7 illustrates a diagram of a three-dimensional bitmap in accordance with various aspects of the present disclosure.

FIG. 8 is a diagram illustrating a two-stage indication of a coefficient selection bitmap in accordance with various aspects of the present disclosure.

FIG. 9 is a diagram illustrating an example of a first CSI part in accordance with various aspects of the present disclosure.

FIG. 10 is a call flow diagram illustrating a method of wireless communication in accordance with various aspects of this present disclosure.

FIG. 11 is a flowchart illustrating methods of wireless communication at a UE in accordance with various aspects of the present disclosure.

FIG. 12 is a flowchart illustrating methods of wireless communication at a UE in accordance with various aspects of the present disclosure.

FIG. 13 is a flowchart illustrating methods of wireless communication at a network node in accordance with various aspects of the present disclosure.

FIG. 14 is a flowchart illustrating methods of wireless communication at a network node in accordance with various aspects of the present disclosure.

FIG. 15 is a diagram illustrating an example of a hardware implementation for an example apparatus and/or network entity.

FIG. 16 is a diagram illustrating an example of a hardware implementation for an example network entity.

### DETAILED DESCRIPTION

A channel state feedback procedure may facilitate channel estimation at a UE. For example, the channel state feedback procedure may include the UE receiving a CSI reference signal (CSI-RS) from a network entity. The UE may generate (or measure) CSI based on, for example, the CSI-RS, and transmit a CSI report including the CSI to the network entity. In some examples, the network entity may transmit a downlink communication to the UE based on the CSI included in the CSI report. A wireless communication system may support UEs that may, at times, move at various speeds. For example, a UE may travel at a medium velocity, and another UE may travel at a high velocity. Aspects presented herein provide for improved CSI that includes time domain or Doppler domain information to assist downlink precoding, for frequency bands such as frequency range 1 (FR1). Thus, aspects disclosed herein enable a Type-II codebook refinement with reduced reporting overhead.

The Type-II CSI may be based on a first matrix associated with a spatial domain (SD), a second matrix associated with a frequency domain, and a third coefficient matrix that indicates a set of NZCs. The coefficient matrix may indicate a variation over a time domain or over a Doppler domain. For non-zero coefficients (NZC) selection, the bitmap size is increased Q times from 2D (SD&FD) to 3D (SD&FD&TD) (e.g., 2LM to 2LMQ), where Q is associated with instances of the coefficient matrix. This increases the reporting overhead, as the bitmap size is increased. Aspects presented herein provide methods and apparatus for two-stage indication CSI for reducing bitmap overhead. In some aspects, the UE may measure multiple occasions of a CSI-RS. The UE may also transmit, at a first stage, a first coefficient selection bitmap for CSI based on measurement of the CSI-RS and associated with a first domain and a second domain, the first coefficient selection bitmap indicating locations of NZCs. The UE may further transmit, at a second stage, a second coefficient selection bitmap indicating, for each NZC location indicated in the first coefficient selection bitmap, a corresponding NZC location in a time domain. In other aspects, the UE may measure multiple occasions of a CSI-RS. The UE may also transmit, at a first stage, a first coefficient selection bitmap for CSI based on measurement of the CSI-RS and associated with a first domain and a second domain, the first coefficient selection bitmap indicating locations of NZCs. The UE may further transmit, at a second stage, a second coefficient selection bitmap indicating, for each subset in each time domain basis of a three-dimensional bitmap and that is associated with one of a first domain or a second domain, whether an NZC is located in the subset. To reduce bitmap overhead, the present disclosure introduces techniques to exploit the channel sparsity in SD&FD&TD (e.g., a three-dimensional bitmap). For example, 1 beam (SD basis) generally only has 1 or 2 FD/TD components with strong enough power. As such, the present disclosure provides for methods and apparatus for reducing a NZC selection bitmap for time domain (TD) CSI. For example, the methods and apparatus provide a CSI reporting enhancement for high/medium UE velocities by exploiting time-domain correlation/Doppler-domain information to assist DL precoding, for example, targeting FR1. The UE may report time-domain channel properties measured via CSI-RS for tracking purposes. The methods and apparatus advantageously enable extrapolation for channel prediction and reduces reporting overhead.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

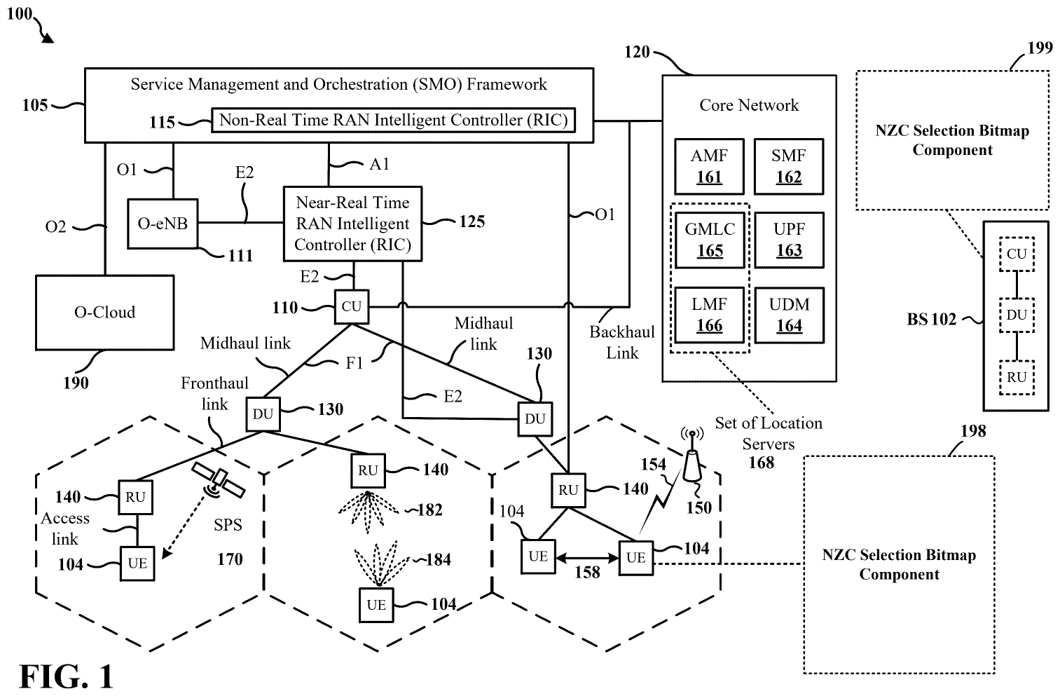

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHZ). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may be configured to include a NZC selection bitmap component 198 configured to measure multiple occasions of a channel state information reference signal (CSI-RS), transmit, at a first stage, a first coefficient selection bitmap for channel state information (CSI) based on measurement of the CSI-RS and associated with a first domain and a second domain, the first coefficient selection bitmap indicating locations of non-zero coefficients (NZCs), and transmit, at a second stage, a second coefficient selection bitmap indicating, for each NZC location indicated in the first coefficient selection bitmap, a corresponding NZC location in a time domain. In other aspects, the UE 104 may be configured to include a NZC selection bitmap component 198 configured to measure multiple occasions of a channel state information reference signal (CSI-RS), transmit, at a first stage, a first coefficient selection bitmap for channel state information (CSI) based on measurement of the CSI-RS and associated with a first domain and a second domain, the first coefficient selection bitmap indicating locations of non-zero coefficients (NZCs), and transmit, at a second stage, a second coefficient selection bitmap indicating, for each subset in each time domain basis of a three-dimensional bitmap and that is associated with one of a first domain or a second domain, whether an NZC is located in the subset. In certain aspects, the base station 102 may include a NZC selection bitmap component 199 configured to provide multiple occasions of a channel state information reference signal (CSI-RS), obtain, at a first stage from a user equipment (UE), a first coefficient selection bitmap for channel state information (CSI) based on measurement of the CSI-RS and associated with a first domain and a second domain, the first coefficient selection bitmap indicating locations of non-zero coefficients (NZCs), and obtain, at a second stage from the UE, a second coefficient selection bitmap indicating, for each NZC location indicated in the first coefficient selection bitmap, a corresponding NZC location in a time domain. In other aspects, the base station 102 may include a NZC selection bitmap component 199 configured to provide multiple occasions of a channel state information reference signal (CSI-RS), obtain, at a first stage from a user equipment (UE), a first coefficient selection bitmap for channel state information (CSI) based on measurement of the CSI-RS and associated with a first domain and a second domain, the first coefficient selection bitmap indicating locations of non-zero coefficients (NZCs), and obtain, at a second stage, a second coefficient selection bitmap indicating, for each subset in each time domain basis of a three-dimensional bitmap and that is associated with one of a first domain or a second domain, whether an NZC is located in the subset. Although the following description may be focused on 5G NR, the concepts described herein may be applicable to other similar areas, such as LTE, LTE-A, CDMA, GSM, and other wireless technologies.

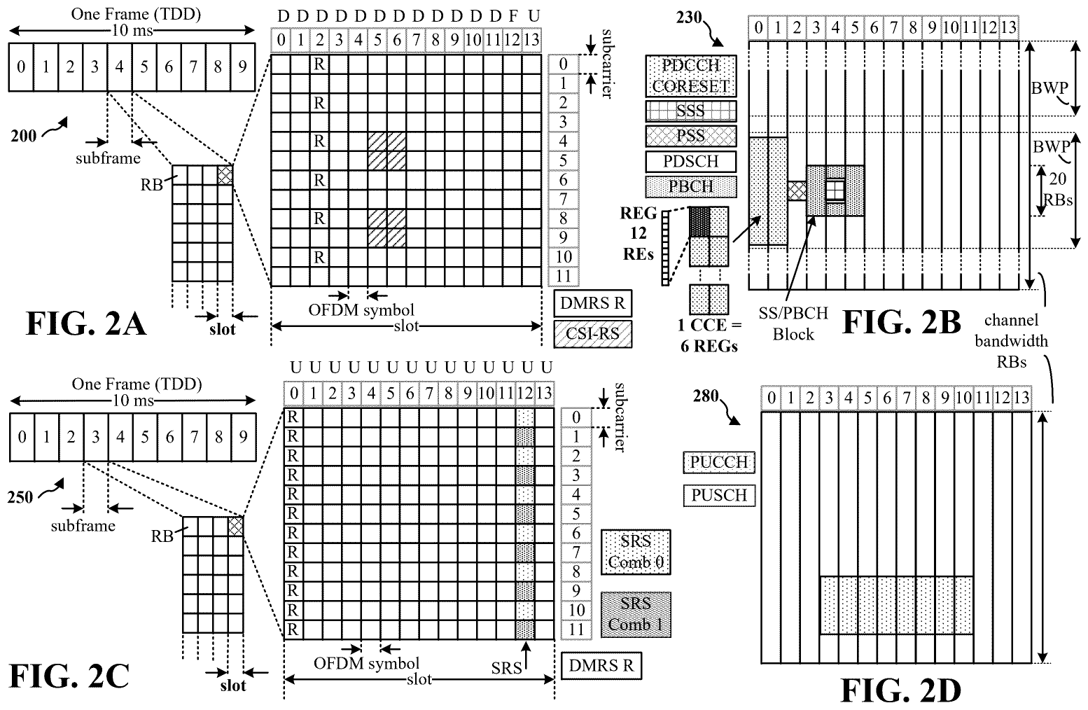

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| μ | SCS Δf = 2^{μ} · 15[kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

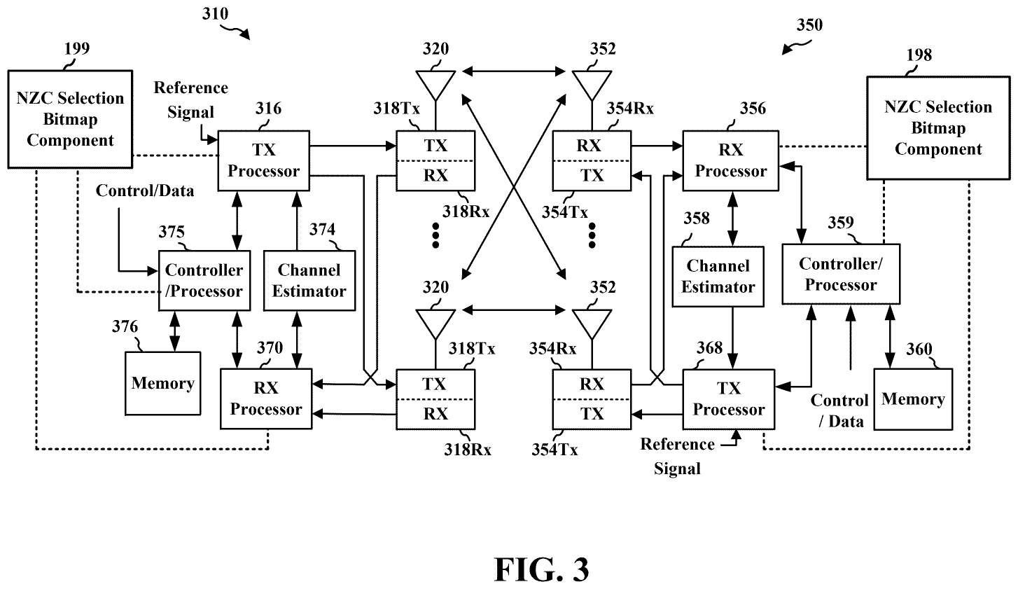

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the NZC selection bitmap component 198 of FIG. 1. At least one of the TX processor 316, the RX processor 370, and the controller/processor 375 may be configured to perform aspects in connection with the NZC selection bitmap component 199 of FIG. 1.

A channel state feedback procedure may facilitate channel estimation at a UE. For example, the channel state feedback procedure may include the UE receiving a CSI-RS from a network entity. The UE may generate (or measure) CSI based on, for example, the CSI-RS, and transmit a CSI report including the CSI to the network entity. The CSI generated by the UE may include one or more components, such as a CSI-RS resource indicator (CRI), a rank indicator (RI), a channel quality indicator (CQI), a precoding matrix indicator (PMI), a layer indicator (LI), etc. In some examples, the network entity may transmit a downlink communication to the UE based on the CSI included in the CSI report.

As an example of wireless communication, massive MIMO improves spectrum efficiency and system throughput in wireless communication systems. Accurate acquisition and feedback of CSI ensures a good performance of massive MIMO systems. Precoding of wireless communication may be based on the CSI feedback. For example, eigenvectors (precoding vectors) of downlink MIMO channels are acquired based on CSI-RS at UEs and reported to a network node, such as a base station via uplink channels. To reduce feedback overhead, the correlation of eigenvectors in the frequency domain may be considered by enhanced Type II (eType II) codebooks.

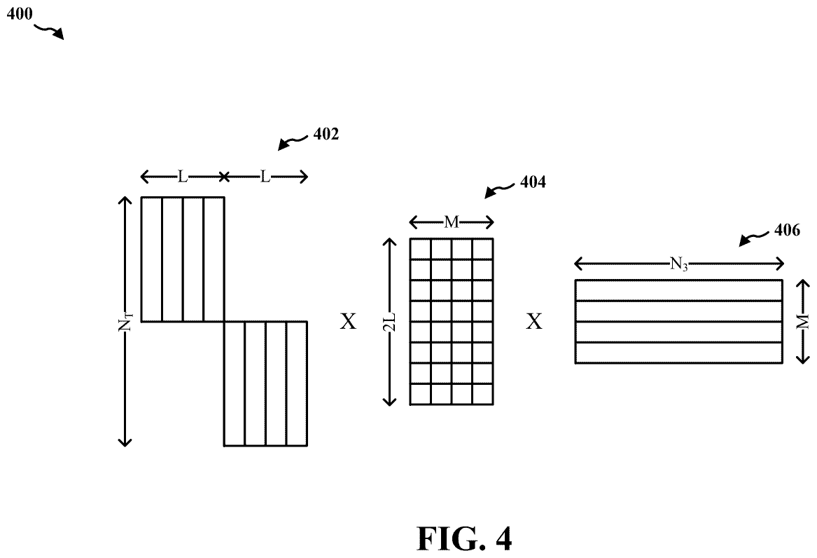

FIG. 4 is a diagram 400 illustrating an eType II codebook in some aspects of wireless communication. The eTypeII codebook may be expressed in accordance with Equation 1, which is provided below:

$$W = {W}_{1} \times \times {W}_{f}^{H} \qquad Eq . 1$$

where W₁ is a first matrix associated with a spatial domain (SD) [symbol] is a second matrix comprising a set of non-zero coefficients (NZCs) (e.g., a coefficient matrix), and

$${W}_{f}^{H}$$

is a third matrix associated with a frequency domain (FD) (where H comprises the eigenvector matrix).

W₁ is represented by a first matrix 402, [symbol] is represented by a second matrix 404, and

$${W}_{f}^{H}$$

is represented by a third matrix 406. In some aspects, the first matrix 402 may be a Nₜ by 2L matrix, where Nₜ is a value based on a number of transmission antennas, and L is a number of beams used for the transmission. The first matrix 402 may be selected from a set of SD bases vectors (e.g., discrete Fourier transform (DFT) bases) for the spatial domain. The second matrix 404 may be a 2L×M matrix including a set of NZCs (which may be representative of subband amplitude and phase coefficients for each antenna polarization). In some aspects, the second matrix 404 is layer-specific, and the CSI may report up to K₀ NZCs for each layer and up to 2K₀ NZCs across all the layers, where K₀ may be equal to β×2LM, β is an RRC configuration parameter, and where M may be an RRC-configured number of FD bases (e.g., FD DFT basis) for compression and may be rank-pair specific. Unreported coefficients are assumed to be, or are set to zero. The coefficients may be quantized based on a preconfigured and/or RRC configured quantized values. The third matrix 406 may be an M×N₃, where N₃ is a number of reported PMIs for different frequency bands (or subbands or portions of subbands).

Due to its large payload size, CSI may be divided into two parts (part1/part2) for conveyance to the network node. CSI part 1 is with a fixed payload (smaller than CSI part 2, and transmitted with higher reliability), and the network node (e.g., gNB) may be able to determine the (larger) payload size of CSI part 2 based on the decoded part 1. That is, the network node may determine the payload size of CSI part 2 by decoding CSI part 1.

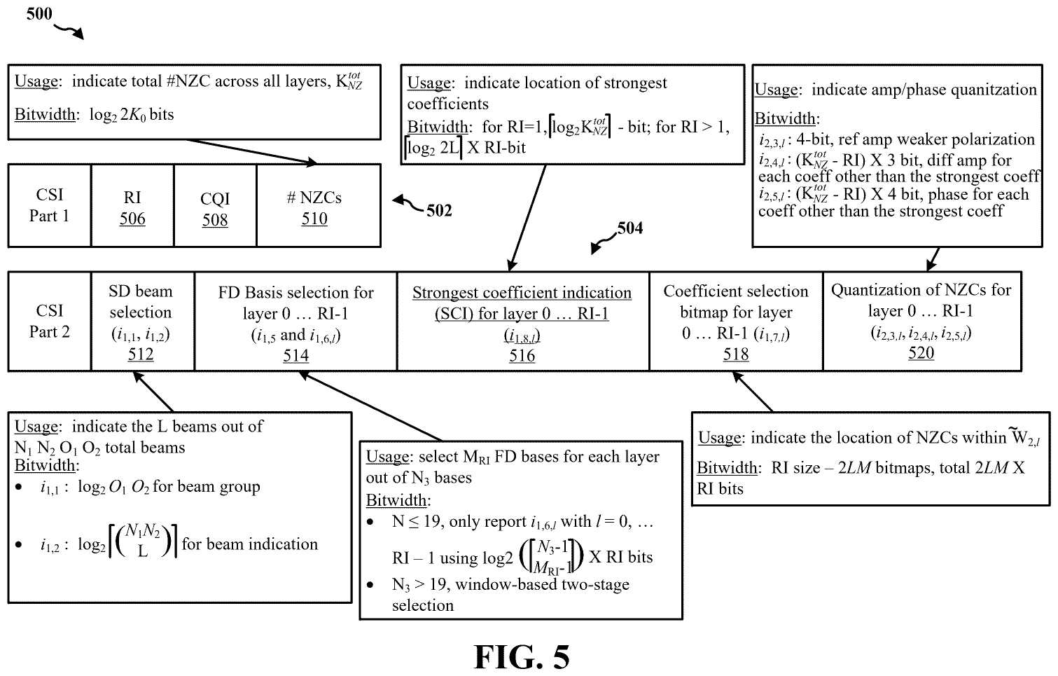

In some aspects of wireless communication, having multiple CSI parts may allow for larger CSI payload sizes. FIG. 5 is a diagram 500 illustrating an example of a two-part CSI. Diagram 500 illustrates a first CSI part (i.e., CSI part 1) 502 and a second CSI part (i.e., CSI part 2) 504. As shown in FIG. 5, CSI part 1 502 may comprise a rank indicator (RI) field 506, a channel quality indicator (CQI) field 508, and a number of NZCs field 510. The RI field 506 may indicate a number of layers associated with the corresponding transmission. The CQI field 508 may comprise the determined CQI. The number of NZCs field 510 may indicate the total number of NZCs across all layers,

$${K}_{N Z}^{tot} .$$

In some aspects, both the RI field 506 and the number of NZCs field 510 may be used to determine a payload size of the CSI part 2 504.

The CSI part 2 504 may comprise an SD beam selection indication field 512, an FD basis selection indication field 514 for each of layers 0 . . . . RI-1, a strongest coefficient indication (SCI) field 516 for each of layers 0 . . . . RI-1, a coefficient selection bitmap field 518 for each of layers 0 . . . . RI-1, and a quantization of NZCs indication field 520 for each of layers 0 . . . . RI-1. The SD beam selection indication field 512 may indicate a selection of L beams out of N₁N₂O₁O₂ total beams. The FD basis selection indication field 514 may indicate a selection of MRI FD bases out of N₃ bases for each layer 0 to RI-1. The SCI field 516 may indicate the location(s) of the strongest coefficients (e.g., in the [symbol] matrix 404) for each of the layers 0 to RI-1. The coefficient selection bitmap field 518 may indicate the location of NZCs within the \tilde{W}₂ matrix 404 for each of the layers 0 to RI-1 (e.g., using a bitmap per layer). The quantization of NZCs indication field 520 may indicate an amplitude and/or phase quantization for NZCs in each layer (e.g., based on the SCI field 516 for the layer).

For medium/high velocity channel, a time-domain codebook may be used to represent the fast-varying (over time instance n) precoding matrix, which is represented in accordance with Equation 2, which is shown below:

$$W ( n ) = {W}_{1} \times ( n ) \times {W}_{f}^{H} \qquad Eq . 2$$

The procedure at the UE is as follows: the UE measures a burst of CSI-RS occasions. The UE extrapolates/predicts to obtain future precoders W(n), n=0, . . . , N₄−1. The SD/FD bases W₁ and W_{f} are assumed constant over time. The UE then performs compression (e.g., time domain (TD) compression) of the extrapolated coefficient matrix [symbol] (n), n=0, . . . , N₄−1 into the Doppler-domain for overhead reduction. Thereafter, the UE reports the CSI.

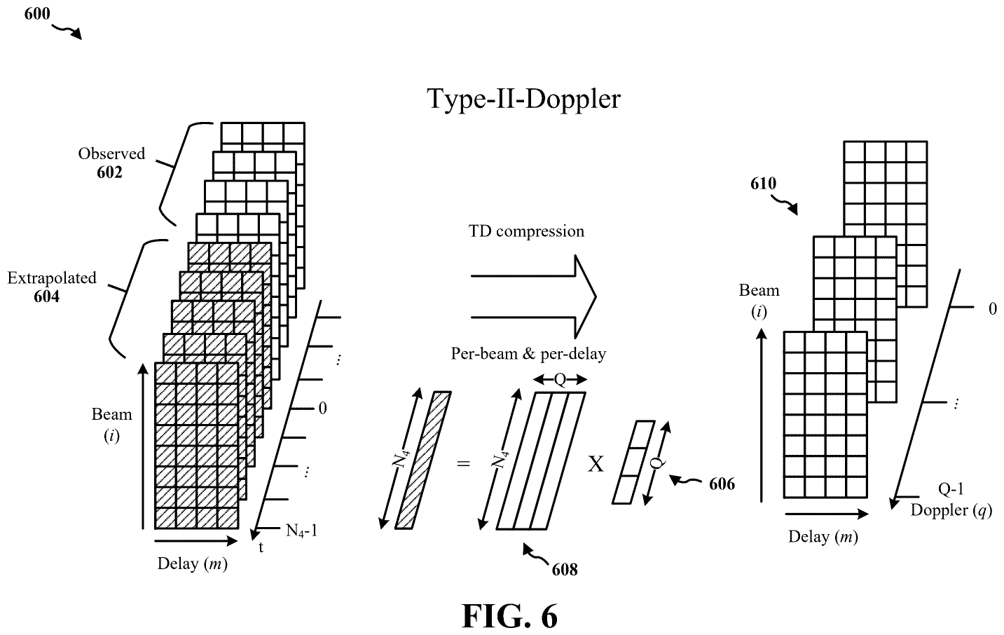

For example, FIG. 6 is a diagram 600 illustrating TD compression. As shown in FIG. 6, a UE measures (or observes) a burst of CSI-RS occasions and generates coefficient matrices 602, each comprising NZCs, based on the CSI-RS occasions. The UE then extrapolates (e.g., predicts) coefficient matrices 604, thereby obtaining a plurality of time (t) domain samples corresponding to coefficient matrices 604 and/or coefficient matrices 602. To compress the time domain samples of the extrapolated coefficient matrices into the Doppler-domain, the number of time domain samples to be compressed (N₄) is projected to the number of selected Doppler bases (Q) (or bases for compression into the time domain). For instance, a coefficient 606 having a length of Q is applied to each N₄ vector 608 in the time domain. The TD compression is performed on a per-beam (i) and per-delay (m) basis. The resulting three-dimensional matrix (or tensor) 610 represents the extrapolated coefficient matrices that are compressed into the Doppler domain (q). In the example shown in FIG. 6, the value of Q is 3. However, it is noted that Q may be other values.

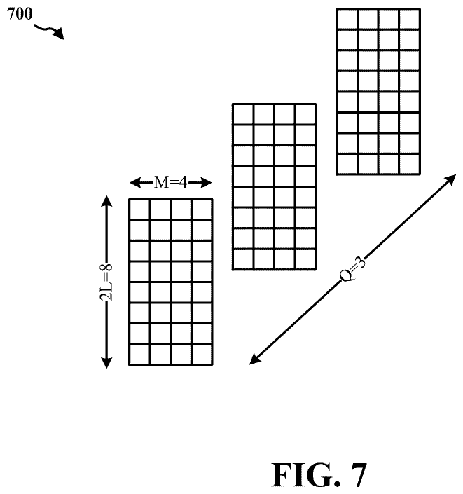

For NZC selection, the bitmap size is increased Q times from 2D (SD&FD) to 3D (SD&FD&TD) (i.e., 2LM to 2LMQ). This increases the reporting overhead, as the bitmap size is increased. For example, FIG. 7 illustrates a diagram 700 of a three-dimensional bitmap, where 2L is equal to 8, M is equal to 4, and Q is equal to 3. Here, the number of bits of the bitmap is increased to 96 from 32 bits (i.e., the number of bits of a two-dimensional bitmap having the same 2L and M values). To reduce bitmap overhead, the present disclosure introduces techniques to exploit the channel sparsity in SD&FD&TD (e.g., a three-dimensional bitmap). For example, 1 beam (SD basis) generally only has 1 or 2 FD/TD components with strong enough power. As such, the present disclosure provides for methods and apparatus for reducing a NZC selection bitmap for time domain (TD) CSI. For example, the methods and apparatus provide a CSI reporting enhancement for high/medium UE velocities by exploiting time-domain correlation/Doppler-domain information to assist DL precoding, for example, targeting FR1. The UE may report time-domain channel properties measured via CSI-RS for tracking purposes. The methods and apparatus advantageously enable extrapolation for channel prediction and reduces reporting overhead.

In particular, the present disclosure provides a 2-stage indication of a coefficient selection bitmap, with the first stage associated with SD&FD (i.e., a two-dimensional bitmap) and a second stage, which indicates the selected spatial, frequency, and time NZCs.

The second stage indication may be provided in one of several ways. For example, in accordance with a first configuration, for each corresponding bit location indicated in the first stage as non-zero (NZ), a corresponding length-Q bitmap is indicated. Thus, the total number of bits (per-layer) for the second stage bitmap

$${K}_{S D \& F D}^{N Z} \cdot Q$$

bits, where

$${K}_{S D \& F D}^{N Z}$$

denotes the total number of NZ bits in the first stage bitmap. For each NZ bit located at (i, m), i=0, . . . , 2L−1, m=0, . . . , M−1 in SD&FD (e.g., in the spatial and frequency domains) in the first stage, it (e.g., the certain NZ bit) represents at least one NZ coefficient (NZC) for q=0, . . . , Q−1 in TD (i.e., in the Doppler domain) in the second stage indication.

In accordance with a second configuration, for (each column of) coefficients associated with each FD basis, a corresponding length-Q bitmap is indicated. Thus, the total number of bits (per-layer) for the second stage bitmap is M. Q bits. For each certain NZ bit located at (q, m), q=0, . . . , Q−1, m=0, . . . , M−1 in TD&FD (i.e., the Doppler and frequency domains) in the second stage bitmap, it (e.g., the certain NZ bit) means the bits in SD (i.e., the length-2L column) just copy the first stage bitmap.

In accordance with a third configuration, for (each row of) coefficients associated with each SD basis, a corresponding length-Q bitmap is indicated. Thus, the total number of bits (per-layer) for the second stage bitmap is 2L. Q bits. For each certain NZ bit located at (i, q), i=0, . . . , 2L−1, q=0, . . . , Q−1 in SD&TD (i.e., the spatial and Doppler domains) in the second stage bitmap, it (e.g., the certain NZ bit) means the bits in FD (i.e., the length-M row) just copy the first stage bitmap.

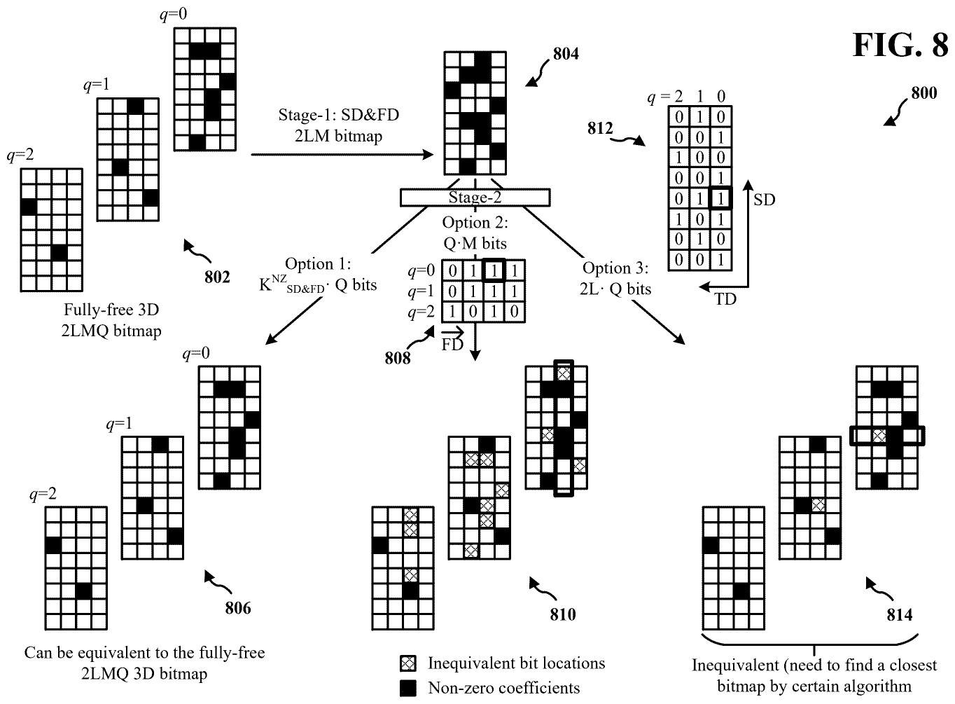

For example, FIG. 8 is a diagram 800 illustrating a two-stage indication of a coefficient selection bitmap in accordance with the various techniques described above. As shown in FIG. 8, a three-dimensional bitmap 802 (e.g., a fully-free three-dimensional 2LMQ bitmap) comprises a plurality of NZCs. To generate a first stage indication 804 (e.g., an SD&FD 2LM bitmap), a union operation may be performed for all NZC locations across all TD bases q=1, . . . , Q. For instance, as shown in FIG. 8, the first stage indication 804 may be an SD&FD 2LM bitmap that indicates the NZC locations of the three-dimensional bitmap 802 in the spatial and frequency domains. The union operation may be beneficial for the first configuration described above to be able to equivalently represent the fully-free three-dimensional bitmap 802.

In accordance with the first configuration described above, the second stage indication may indicate, for each selected location in the first stage bitmap (e.g., the first stage indication 804), the selected Doppler bases NZCs. As shown in FIG. 8, the second stage indication may result in a three-dimensional bitmap 806 that is equivalent to the fully-free 2LMQ three-dimensional bitmap 802.

In accordance with the second configuration described above, a second stage indication (e.g., a Q×M indication table) 808 may be generated. The second stage indication 808 may indicate, for each q bitmap (e.g., q=0, q=1, q=2, etc.) of the three-dimensional bitmap 802, whether a particular column thereof (comprising NZCs associated with an FD basis) indicates an NZC location. For example, as shown in FIG. 8, row 0 of the second stage indication 808 corresponds to the q=0 bitmap of the three-dimensional bitmap 802, row 1 of the second stage indication 808 corresponds to the q=1 bitmap of the three-dimensional bitmap 802, and row 2 of the second stage indication 808 corresponds to the q=2 bitmap of the three-dimensional bitmap 802. The columns of row 0 correspond to the columns of the q=0 bitmap of the three-dimensional bitmap 802, the columns of row 1 correspond to the columns of the q=1 bitmap of the three-dimensional bitmap 802, and the columns of row 2 correspond to the columns of the q=2 bitmap of the three-dimensional bitmap 802.

For row 0 of the second stage indication 808, a value of “0” may be indicated for the first column, as the first column of the q=0 bitmap of the three-dimensional bitmap 802 does not indicate any NZC locations. A value of “1” may be indicated for the second, third, and fourth columns of row 0, as the second, third, and fourth columns of the q=0 bitmap of the three-dimensional bitmap 802 indicate NZC location(s). For row 1 of the second stage indication 808, a value of “0” may be indicated for the first column, as the first column of the q=1 bitmap of the three-dimensional bitmap 802 does not indicate any NZC locations. A value of “1” may be indicated for the second, third, and fourth columns of row 1, as the second, third, and fourth columns of the q=1 bitmap of the three-dimensional bitmap 802 indicate NZC location(s). For row 2 of the second stage indication 808, a value of “0” may be indicated for the second and fourth columns, as the second and fourth columns of the q=2 bitmap of the three-dimensional bitmap 802 do not indicate any NZC locations. A value of “1” may be indicated for the first and third columns of row 2, as the first and third columns of the q=2 bitmap of the three-dimensional bitmap 802 indicate NZC location(s).

In accordance with the second configuration, the first stage indication 804 and the second stage indication 808 may be utilized (e.g., by a network node) to reconstruct the three-dimensional bitmap 802 (shown as a reconstructed three-dimensional bitmap 810). For example, with reference to the q=0 bitmap of the reconstructed three-dimensional bitmap 810, the values stored in row 0 of the second stage indication 808 may be utilized to generate the q=0 bitmap of the reconstructed three-dimensional bitmap 810. For instance, because a value of “0” is stored in the first column of row 0 of the second stage indication 808 (indicating that the first column of the q=0 bitmap of the three-dimensional bitmap 802 does not indicate any NZC locations(s)), the first column of the q=0 bitmap of the reconstructed three-dimensional bitmap 810 is empty. Because a value of “1” is stored in the second column of row 0 of the second stage indication 808 (indicating that second column of the q=0 bitmap of the three-dimensional bitmap 802 indicates NZC location(s), the second column of the q=0 bitmap of the reconstructed three-dimensional bitmap 810 stores the same NZC indication(s) as the second column of the first stage indication 804 (i.e., the NZC indication(s) of the second column of the first stage indication 804 are copied into the second column of the q=0 bitmap of the reconstructed three-dimensional bitmap 810. Because a value of “1” is stored in the third column of row 0 of the second stage indication 808 (meaning that third column of the q=0 bitmap of the three-dimensional bitmap 802 indicates NZC location(s), the third column of the q=0 bitmap of the reconstructed three-dimensional bitmap 810 stores the same NZC indication(s) as the third column of the first stage indication 804 (i.e., the NZC indication(s) of the third column of the first stage indication 804 are copied into the third column of the q=0 bitmap of the reconstructed three-dimensional bitmap 810. Because a value of “1” is stored in the fourth column of row 0 of the second stage indication 808 (meaning that fourth column of the q=0 bitmap of the three-dimensional bitmap 802 indicates NZC location(s), the fourth column of the q=0 bitmap of the reconstructed three-dimensional bitmap 810 stores the same NZC indication(s) as the fourth column of the first stage indication 804 (i.e., the NZC indication(s) of the fourth column of the first stage indication 804 are copied into the fourth column of the q=0 bitmap of the reconstructed three-dimensional bitmap 810. The q=1 and q=2 bitmaps of the reconstructed three-dimensional bitmap 810 are generated in a similar manner.

However, as shown in FIG. 8, the second configuration introduces inequivalent bit locations. For instance, when comparing the q=0 bitmap of the reconstructed three-dimensional bitmap 810 to the q=0 bitmap of the three-dimensional bitmap 802, there are three inequivalent bit locations (i.e., bit locations that are not indicated in the q=0 bitmap of the three-dimensional bitmap 802). When comparing the q=1 bitmap of the reconstructed three-dimensional bitmap 810 to the q=1 bitmap of the three-dimensional bitmap 802, there are six inequivalent bit locations (i.e., bit locations that are not indicated in the q=1 bitmap of the three-dimensional bitmap 802). When comparing the q=2 bitmap of the reconstructed three-dimensional bitmap 810 to the q=2 bitmap of the three-dimensional bitmap 802, there are three inequivalent bit locations (i.e., bit locations that are not indicated in the q=2 bitmap of the three-dimensional bitmap 802).

The strongest NZC may also be indicated via the second stage indication 808. In the example shown in FIG. 8, the strongest coefficient is identified as being in the third column of row 0 of the second stage indication 808. Accordingly, the bases mapped to Doppler domain index 0 and mapped to FD bases index 2 is selected, which means that the third column of the q=0 bitmap of the reconstrued three-dimensional matrix (e.g., 810) is selected.

In accordance with the third configuration described above, a second stage indication (e.g., a 2L×Q indication table) 812 may be generated. The second stage indication 812 may indicate, for each q bitmap (e.g., q=0, q=1, q=q, etc.) of the three-dimensional bitmap 802, whether a particular row thereof (comprising NZCs associated with an SD basis) indicates an NZC location. For example, as shown in FIG. 8, column 0 of the second stage indication 812 corresponds to the q=0 bitmap of the three-dimensional bitmap 802, column 1 of the second stage indication 812 corresponds to the q=1 bitmap of the three-dimensional bitmap 802, and column 2 of the second stage indication 812 corresponds to the q=2 bitmap of the three-dimensional bitmap 802. Each element or cell of column 0 corresponds to a respective row of the q=0 bitmap of the three-dimensional bitmap 802, each element or cell of column 1 corresponds to a respective row of the q=1 bitmap of the three-dimensional bitmap 802, and each element or cell of column 2 corresponds to a respective row of the q=2 bitmap of the three-dimensional bitmap 802.

For each of the first, third, and seventh cells of column 0 of the second stage indication 812, a value of “0” may be indicated, as each of the first, third, and seventh rows of the q=0 bitmap of the three-dimensional bitmap 802 does not indicate any NZC locations. A value of “1” may be indicated for each of the second, fourth, fifth, sixth, and eighth cells of column 0 of the second stage indication 812, as each of the second, fourth, fifth, sixth, and eighth rows of the q=0 bitmap of the three-dimensional bitmap 802 indicate NZC location(s). For each of the second, third, fourth, sixth, and eighth cells of column 1 of the second stage indication 812, a value of “0” may be indicated, as each of the second, third, fourth, sixth, and eighth rows of the q=1 bitmap of the three-dimensional bitmap 802 does not indicate any NZC locations. A value of “1” may be indicated for each of the first, fifth, and seventh cells of column 1 of the second stage indication 812, as each of the first, fifth, and seventh rows of the q=1 bitmap of the three-dimensional bitmap 802 indicate NZC location(s). For each of the first, second, fourth, fifth, seventh, and eighth cells of column 2 of the second stage indication 812, a value of “0” may be indicated, as each of the first, second, fourth, fifth, seventh, and eighth rows of the q=2 bitmap of the three-dimensional bitmap 802 does not indicate any NZC locations. A value of “1” may be indicated for each of the third and sixth cells of column 2 of the second stage indication 812, as each of the third and sixth rows of the q=2 bitmap of the three-dimensional bitmap 802 indicate NZC location(s).

In accordance with the third configuration, the first stage indication 804 and the second stage indication 812 may be utilized (e.g., by a network node) to reconstruct the three-dimensional bitmap 802 (shown as a reconstructed three-dimensional bitmap 814). For example, with reference to the q=0 bitmap of the reconstructed three-dimensional bitmap 814, the values stored in column 0 of the second stage indication 812 are utilized to generate the q=0 bitmap of the reconstructed three-dimensional bitmap 814. For instance, because a value of “0” is stored in each of the first, third, and seventh cells of column 0 of the second stage indication 812 (indicating that the first, third, and seventh rows of the q=0 bitmap of the three-dimensional bitmap 802 does not indicate any NZC locations(s)), the first, third, and seventh rows of the q=0 bitmap of the reconstructed three-dimensional bitmap 814 are empty. Because a value of “1” is stored in each of the second, fourth, fifth, sixth, and eighth cells of column 0 of the second stage indication 812 (indicating that second, fourth, fifth, sixth, and eighth rows of the q=0 bitmap of the three-dimensional bitmap 802 indicate NZC location(s)), the second, fourth, fifth, sixth, and eighth rows of the q=0 bitmap of the reconstructed three-dimensional bitmap 814 store the same NZC indication(s) as the second, fourth, fifth, sixth, and eighth rows of the first stage indication 804 (i.e., the NZC indication(s) of the second, fourth, fifth, sixth, and eighth rows of the first stage indication 804 are copied into the second, fourth, fifth, sixth, and eighth rows of the q=0 bitmap of the reconstructed three-dimensional bitmap 814. The q=1 and q=2 bitmaps of the reconstructed three-dimensional bitmap 814 are generated in a similar manner.

However, as shown in FIG. 8, the third configuration introduces inequivalent bit locations. For instance, when comparing the q=0 bitmap of the reconstructed three-dimensional bitmap 814 to the q=0 bitmap of the three-dimensional bitmap 802, there is one inequivalent bit location (i.e., a bit location that is not indicated in the q=0 bitmap of the three-dimensional bitmap 802). When comparing the q=1 bitmap of the reconstructed three-dimensional bitmap 814 to the q=1 bitmap of the three-dimensional bitmap 802, there is one inequivalent bit location (i.e., a bit location that is not indicated in the q=1 bitmap of the three-dimensional bitmap 802). When comparing the q=2 bitmap of the reconstructed three-dimensional bitmap 814 to the q=2 bitmap of the three-dimensional bitmap 802, there are no inequivalent bit locations.

The strongest NZC may also be indicated via the second stage indication 812. In the example shown in FIG. 8, the strongest coefficient is identified as being in the fifth cell of column 0 of the second stage indication 812. Accordingly, the bases mapped to Doppler domain index 0 and mapped to SD bases index 5 is selected, which means that the fifth row of the q=0 bitmap of the reconstrued three-dimensional matrix (e.g., 814) is selected.

In some aspects, for the second and third configurations, other algorithms may be utilized for the two-stage indication (e.g., an algorithm that jointly determines the first and second stage indications (e.g., bitmaps) according to the amplitudes of \tilde{W}₂ coefficients.

The overall bitmap size for the configurations described above vary. For example, in a configuration in which 2L is equal to 8, M is equal to 4, and Q is equal to 3, the 3D fully-free bitmap has a size of 96 bits (e.g., 2LMQ), the bitmaps of the first configuration have a total size of 62 bits

$$( e . g . , 2 LM + {K}_{S D \& F D}^{N Z} \cdot Q ) ,$$

the bitmaps of the second configuration have a total size of 44 bits (e.g., 2LM+MQ), and the bitmaps for the third configuration have at total size of 56 bits (e.g., 2LM+2LQ).

For the maximum total NZCs in non-TD CSI, K₀=┌β2LM₁┐ may be defined as the maximum number of NZCs within a layer, where β is a scaling parameter and may be configured, for example, as ¼, ½, or ¾, where Mi is the number of selected FD bases assuming rank-1, and 2K₀ is the maximum number of NZCs across all layers. In one configuration, for the total maximum total NZCs defined for TD CSI, an overall K_{0,3D} in SD&FD&TD may be defined, where K_{0,3D}=┌β_{3D}2LM₁ Q┐. In some aspects, a different value for β may be introduced. In another configuration, for the total maximum total NZCs defined for TD CSI, K₀ in SD&FD may be reused. Additionally, a scaling parameter β_{TD} may be defined for TD (e.g., K_{0,3D}=┌β_{TD}K₀Q┐ or ┌β_{TD}β2LM₁Q┐. K₀=┌β2LM₁┐ may be defined as the maximum number of NZCs per-TD-basis or per-TD-basis-union (and per-layer). In accordance with this configuration, the existing mechanisms in SD&FD may be advantageously reused, and only TD may be defined. For either of these configurations, K_{0,3D} may be defined as the maximum number of NZCs within a layer, and 2K_{0,3D} may be defined as the number of NZCs across all layers.

In the first configuration described above,

$${K}_{S D \& F D}^{N Z}$$

can vary, and thus, the bitmap size

$$( e . g . , 2 LM + {K}_{SD \& FD}^{NZ} \cdot Q )$$

may not be fixed. In one configuration, a larger number of bits (e.g., a number of bits no smaller) than

$${K}_{SD \& FD}^{NZ}$$

may be reserved for the second stage bitmap report. The first and second stage bitmap reports may be included in CSI part 2. This “overbooked” size can be

$${K}_{SD \& FD}^{NZ , max} = {K}_{0 , 3 D} = ⌈ {β}_{3 D} 2 {LM}_{1} Q ⌉$$

(e.g., when an overall K_{0,3D} is defined as described above), or additionally with some down-scaling

$$( e . g . , {K}_{SD \& FD}^{NZ , max} = γ {K}_{0 , 3 D} , where 0 < γ < 1 ) ,$$

which makes it like (e.g., similar to) K₀ (e.g., when reused in SD&FD, as described above). This overbooked bit size can be

$${K}_{SD \& FD}^{NZ , max} = {K}_{0} = ⌈ β2 {LM}_{1} ⌉$$

(e.g., when K₀ is reused in SD&FD), as described above. For the case

$${K}_{SD \& FD}^{NZ} < {K}_{SD \& FD}^{NZ , max} ,$$

partial bits (e.g., MSBs (most significant bits) or LSBs (least significant bits)) may be used, and zero-padding may be used.

In another configurations the value of

$${K}_{SD \& FD}^{NZ}$$

may be reported in CSI part 1, and the

$${K}_{SD \& FD}^{NZ}$$

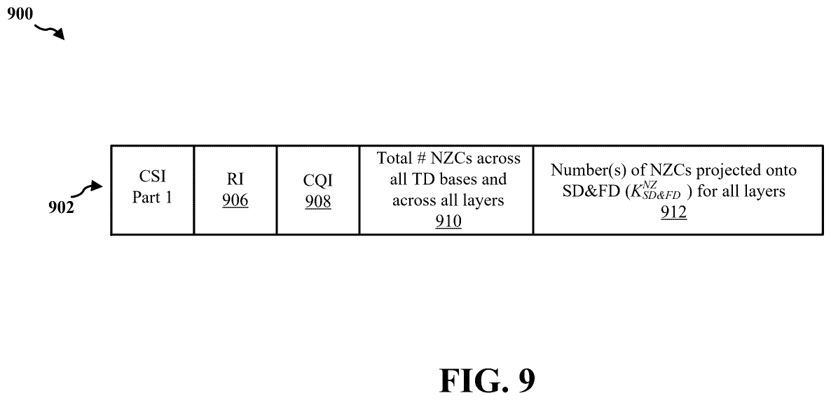

bits may used for the second stage bitmap report (in CSI part 2). For example, FIG. 9 is a diagram 900 illustrating an example of a first CSI part (i.e., CSI part 1) 902. As shown in FIG. 9, the CSI part 1 902 may comprise an RI field 906, a CQI field 908, a number of NZCs field 910 across all TD bases and across all layers, and a number of NZCs projected onto SD&FD field 912 for all layers. The RI field 906 may indicate a number of layers associated with the corresponding transmission. The CQI field 908 may comprise the determined CQI. The number of NZCs field 910 may indicate the total number of NZCs across all TD bases and across all layers. The number of NZCs projected onto SD&FD field 912 may indicate the value of

$${K}_{SD \& FD}^{NZ} .$$

It is noted that the number of NZCs may be indicated per-layer, and thus, the total rank reports of

$${K}_{SD \& FD}^{NZ}$$

may be reported in the number of NZCs projected onto SD&FD field 912 of the CSI part 1 902. For a reported

$${K}_{SD \& FD}^{NZ}$$

(of a certain layer) in the CSI part 1 902, a maximum value of

$${K}_{SD \& FD}^{NZ}$$

may be K_{0,3D}=┌β_{3D}2LM₁Q┌ or 2LM₁, where an overall K_{0,3D} is defined in SD&FD&TD, as described above. Thus, a total of ┌log₂ K_{0,3D}┐ bits or ┌log₂ 2LM₁┐ bits or ┌log₂ min(K_{0,3D}, 2LM₁)┐ bits may be used to report a

$${K}_{SD \& FD}^{NZ} .$$

Alternatively, a maximum value of

$${K}_{SD \& FD}^{NZ}$$

may be K₀=┌β2LM₁┐ (maximum number of NZCs (e.g., per-TD-basis-union and per-layer)), where K₀ is reused in SD&FD, as described above. Thus, a total of ┌log₂ K₀┐ bits may be enough to report a

$${K}_{SD \& FD}^{NZ} .$$

In yet another configuration, the first stage indication and the second stage indication may be transmitted in the CSI part 2 (e.g., the CSI part 2 504 shown in FIG. 5). The number of NZ bit values of the first stage indication may be fixed (e.g., K₀=2LMβ, where L, M, and, β are RRC configuration parameters).

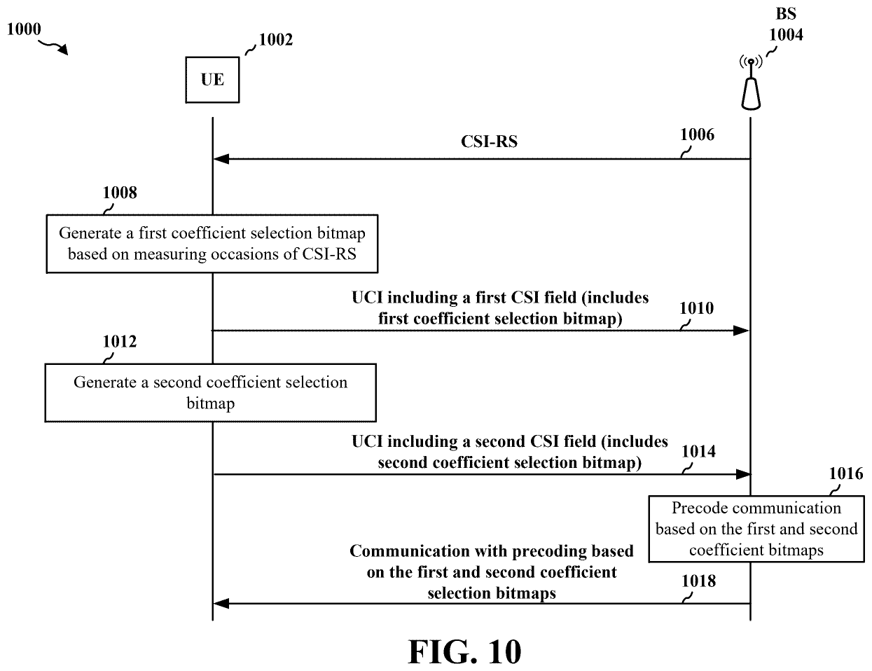

FIG. 10 is a call flow diagram 1000 illustrating a method of wireless communication in accordance with various aspects of this present disclosure. Although aspects are described for a network node 1004, the aspects may be performed by a network node in aggregation and/or by one or more components of a network node 1004 (e.g., such as a CU 110, a DU 130, and/or an RU 140). As shown in FIG. 10, a UE 1002 may receive, at 1006, multiple (e.g., a burst of) CSI-RS from the network node 1004. The UE 1002 may measure the multiple CSI-RS occasions and extrapolate (e.g., predict) future precoders.

At 1008, the UE 1002 may generate, at a first stage, a first coefficient selection bitmap for CSI based on measuring occasions of CSI-RS. The first coefficient selection bitmap may indicate locations of NZCs in the spatial domain and the frequency domain.

At 1010, the UE 1002 may transmit UCI including a first CSI field that includes the first coefficient selection bitmap to the network node 1004. The first CSI field may be included in the CSI part 1 (e.g., the CSI part 1 502, as shown in FIG. 5) or the CSI part 2 (e.g., the CSI part 2 504, as shown in FIG. 5)

At 1012, the UE 1002 may generate, at a second stage, a second coefficient selection bitmap. In one configuration, the second coefficient selection bitmap may indicate, for each NZC location indicated in the first coefficient selection bitmap, a corresponding NZC location in a time domain. In another configuration, the second coefficient selection bitmap may indicate, for each column in each time domain basis of a three-dimensional bitmap (e.g., a three-dimensional 2LMQ bitmap) and that is associated with the frequency domain, whether an NZC is located in the column. In accordance with such a configuration, the second coefficient selection bitmap indicates the NCZs in the frequency domain and the time domain. In a further configuration, the second coefficient selection bitmap may indicate, for each row in each time domain basis of the three-dimensional bitmap and that is associated with the spatial domain, whether an NZC is located in the row. In accordance with such a configuration, the second coefficient selection bitmap indicates the NCZs in the spatial domain and the time domain.

At 1014, the UE 1002 may transmit UCI including a second CSI field that includes the second coefficient selection bitmap to the network node 1004. The second CSI field may be included in the CSI part 1 (e.g., the CSI part 1 502) or the CSI part 2 (e.g., the CSI part 2 504, as shown in FIG. 5). In a configuration in which the second coefficient selection bitmap indicates, for each NZC location indicated in the first coefficient selection bitmap, a corresponding NZC location in a time domain, a number of bits larger (e.g., no smaller) than the total number of NZ bits in the first coefficient selection map may be reserved in a CSI part (e.g., the CSI part 2 504, as shown in FIG. 5) for reporting the second coefficient selection bitmap. In accordance with such a configuration, a number of bits no smaller than a total number of NZ bits in the first coefficient selection bitmap is reserved in a CSI field (e.g., the second CSI field) for reporting the second coefficient selection bitmap. In another configuration, a total number of NZ bits in the first coefficient selection bitmap may be reported in the CSI part 1, and the total number of NZ bits may be used for reporting the second coefficient selection bitmap in the CSI part 2. It is noted that the second coefficient selection bitmap may be generated before the first coefficient selection bitmap is transmitted to the network node 1004 at 1010.

At 1016, the network node 1004 may precode communication based on the first and second coefficient bitmaps.

At 1018, the UE 1002 may receive the communication that is precoded by the network node 1004 based on the first and second coefficient bitmaps.

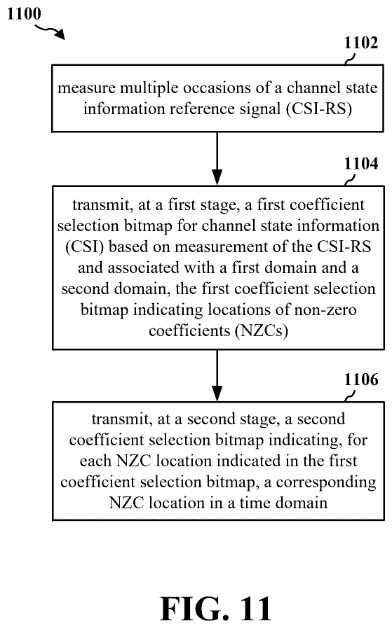

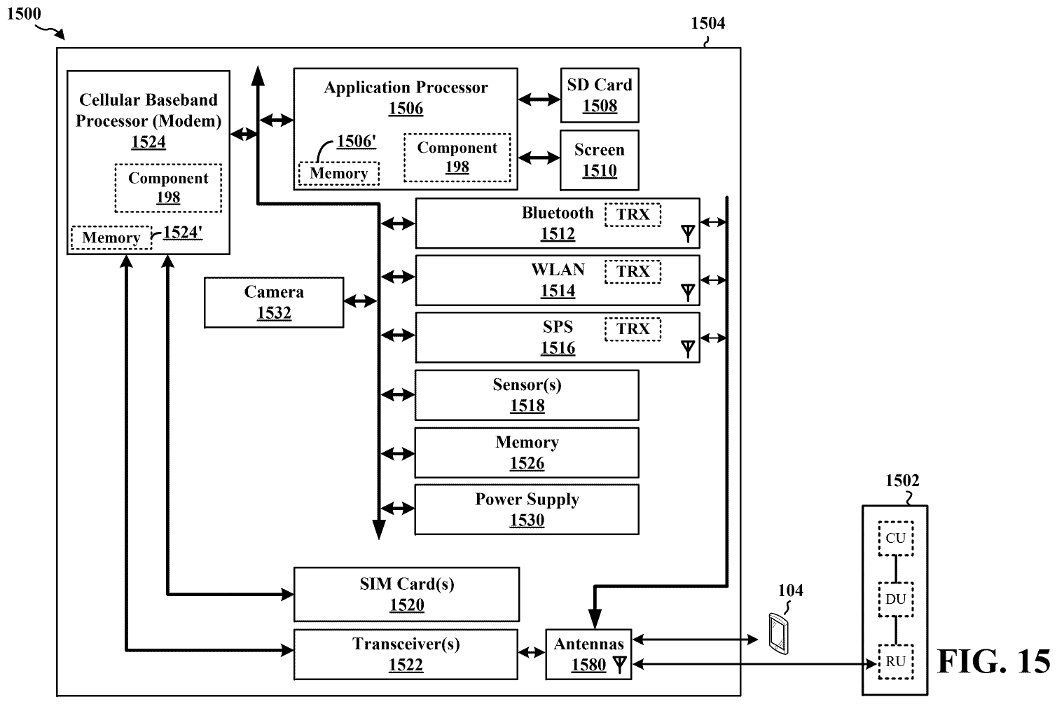

FIG. 11 is a flowchart 1100 illustrating methods of wireless communication at a UE in accordance with various aspects of the present disclosure. The method may be performed by a UE. The UE may be the UE 104, 350, 1002, or the apparatus 1504 in the hardware implementation of FIG. 15.

As shown in FIG. 11, at 1102, the UE may measure multiple occasions of CSI-RS. For example, referring to FIG. 10, the UE 1002 may measure multiple occasions of CSI-RS provided by the network node 1004. As described above with reference to FIG. 6, the UE may generate coefficient matrices 602 based on the CSI-RS occasions and extrapolate coefficient matrices 604, thereby obtaining a plurality of time (1) domain samples corresponding to coefficient matrices 604 and/or coefficient matrices 602.

At 1104, at a first stage, a first coefficient selection bitmap for CSI based on measurement of the CSI-RS and associated with a first domain and a second domain may be transmitted, the first coefficient selection bitmap indicating locations of NZCs. For example, referring to FIG. 10, the UE 1002 may generate the first coefficient selection bitmap for CSI based on measurement of the CSI-RS at 1008 and may transmit the first coefficient selection bitmap at 1010. As described above with reference to FIG. 8, the UE may transmit the first stage indication 804 as the coefficient selection bitmap (e.g., 804) at the first stage.

In some aspects, the first domain may be a frequency domain, and the second domain may be a spatial domain. For example, referring to FIG. 10, the first coefficient selection bitmap transmitted at 1010 may be associated with the frequency domain and the spatial domain.

In some aspects, the first coefficient selection bitmap may be transmitted in a first CSI field included in UCI. For example, referring to FIG. 10, the first coefficient selection bitmap transmitted at 1010 may be transmitted in a first CSI field (e.g., in the CSI part 1 502 or 902 or the CSI part 2 504, as respectively shown in FIGS. 5 and 9) included in UCI.

At 1106, at a second stage, a second coefficient selection bitmap indicating, for each NZC location indicated in the first coefficient selection bitmap, a corresponding NZC location in a time domain may be transmitted. For example, referring to FIG. 10, the UE 1002 may generate, at 1012, the second coefficient selection bitmap indicating, for each NZC location indicated in the first coefficient selection bitmap, a corresponding NZC location in a time domain and may transmit the second coefficient selection bitmap at 1014.

In some aspects, the second coefficient selection bitmap may be transmitted in a second CSI field included in the UCI. For example, referring to FIG. 10, the second coefficient selection bitmap transmitted at 1014 may be transmitted in a second CSI field (e.g., in a CSI field in the CSI part 1 502 or in the coefficient selection bitmap field 518 in the CSI part 2 504, as shown in FIG. 5).

In some aspects, the first coefficient selection bitmap and the second coefficient selection bitmap are transmitted in a second CSI part included in UCI, and wherein the second CSI part is transmitted subsequent to a first CSI part in the UCI. For example, referring to FIG. 10, in lieu of transmitting the first coefficient selection bitmap in the CSI part 1, both the first coefficient selection bitmap and the second coefficient bitmap may be transmitted in the CSI part 2 (e.g., the CSI part 2 504, as shown in FIG. 5) at 1014.

In some aspects, a number of bits no smaller than a total number of NZ bits in the first coefficient selection bitmap may be reserved in a CSI field (e.g., the second CSI field) for reporting the second coefficient selection bitmap. For example, referring to FIG. 10, a number of bits no smaller than a total number of NZ bits in the first coefficient selection bitmap may be reserved in the second CSI part transmitted at 1014 for reporting the second coefficient selection bitmap.

In some aspects, a total number of NZ bits in the first coefficient selection bitmap is reported in a first CSI part. For example, referring to FIG. 10, a total number of NZ bits in the first coefficient selection bitmap may be reported in a first CSI part (e.g., in the number of NZCs projected onto SD&FD field 912 of the CSI part 1 902 shown in FIG. 9).

In some aspects, the total number of NZ bits may be used for reporting the second coefficient selection bitmap in a second CSI part. For example, referring to FIG. 10, the total number of NZ bits (e.g., reported in the CSI part 1) may be used for reporting the second coefficient selection bitmap in the CSI part 2 at 1014.

In some aspects, communication with precoding based on the first coefficient selection bitmap and the second coefficient selection bitmap may be received. For example, referring to FIG. 10, at 1018, the UE may receive communication with precoding based on the first coefficient selection bitmap and the second coefficient selection bitmap from the network node 1004.

In some aspects, a maximum number of NZ bits associated with the first coefficient selection bitmap and the second coefficient selection bitmap may be based on a scaling parameter associated with the frequency domain, the spatial domain, and the time domain, a number of beams utilized for transmission, a number of selected frequency domain basis associated with a first rank, and a number of selected Doppler basis. For example, referring to FIG. 10, the maximum number of NZ bits associated with the first and second coefficient selection maps generated at 1008 and 1012 may be based on a scaling parameter associated with the frequency domain, the spatial domain, and the time domain, a number of beams utilized for transmission, a number of selected frequency domain basis associated with a first rank, and a number of selected Doppler basis.

In some aspects, a maximum number of NZ bits associated with the first coefficient selection bitmap and the second coefficient selection bitmap may be based on at least a first scaling parameter, a second scaling parameter associated with the time domain, a number of beams utilized for transmission, a number of selected frequency domain basis associated with a first rank, and a number of selected Doppler basis. For example, referring to FIG. 10, the maximum number of NZ bits associated with the first and second coefficient selection maps generated at 1008 and 1012 may be based on at least a first scaling parameter, a second scaling parameter associated with the time domain, a number of beams utilized for transmission, a number of selected frequency domain basis associated with a first rank, and a number of selected Doppler basis.

In some aspects, the maximum number of NZ bits may be defined per-time domain-basis or a union of the per-time domain-basis. For example, referring to FIG. 10, the maximum number of NZ bits associated with the first and second coefficient selection maps generated at 1008 and 1012 may be defined per-time domain-basis or a union of the per-time domain-basis.

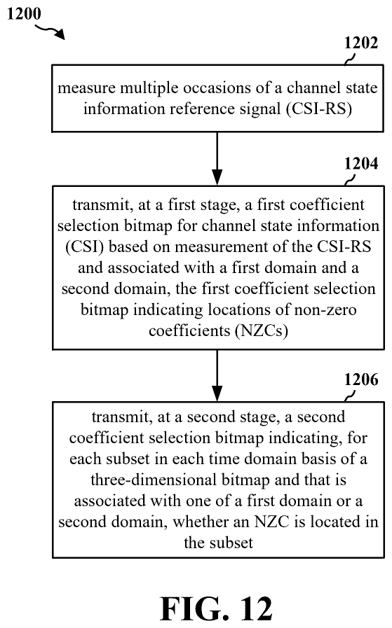

FIG. 12 is a flowchart 1200 illustrating methods of wireless communication at a UE in accordance with various aspects of the present disclosure. The method may be performed by a UE. The UE may be the UE 104, 350, 1002, or the apparatus 1504 in the hardware implementation of FIG. 15.

As shown in FIG. 12, at 1202, the UE may measure multiple occasions of CSI-RS. For example, referring to FIG. 10, the UE may measure multiple occasions of CSI-RS provided by the network node 1004. As described above with reference to FIG. 6, the UE may generate coefficient matrices 602 based on the CSI-RS occasions and extrapolate coefficient matrices 604, thereby obtaining a plurality of time (1) domain samples corresponding to coefficient matrices 604 and/or coefficient matrices 602.

At 1204, at a first stage, a first coefficient selection bitmap for CSI based on measurement of the CSI-RS and associated with a first domain and a second domain may be transmitted, the first coefficient selection bitmap indicating locations for NZCs. For example, referring to FIG. 10, the UE 1002 may generate the first coefficient selection bitmap for CSI based on measurement of the CSI-RS at 1008 and may transmit the first coefficient selection bitmap at 1010. As described above with reference to FIG. 8, the UE may transmit the first coefficient selection bitmap (e.g., 804) at the first stage.

In some aspects, the first domain may be a frequency domain, and the second domain may be a spatial domain. For example, referring to FIG. 10, the first coefficient selection bitmap transmitted at 1010 may be associated with the frequency domain and the spatial domain.

In some aspects, the first coefficient selection bitmap may be transmitted in a first CSI part included in UCI. For example, referring to FIG. 10, the first coefficient selection bitmap transmitted at 1010 may be transmitted in the CSI part 1 (e.g., the CSI part 1 502 or 902, as respectively shown in FIGS. 5 and 9) included in UCI.

At 1206, at a second stage, a second coefficient selection bitmap indicating, for each subset in each time domain basis of a three-dimensional bitmap and that is associated with one of a first domain or a second domain, whether an NZC is located in the subset may be transmitted. For example, referring to FIG. 10, the UE 1002 may generate, at 1012, the second coefficient selection bitmap indicating, for each subset in each time domain basis of a three-dimensional bitmap and that is associated with one of a first domain or a second domain, whether an NZC is located in the subset and may transmit the second coefficient selection bitmap at 1014.

In some aspects, the second coefficient selection bitmap may be transmitted in a second CSI part included in the UCI. For example, referring to FIG. 10, the second coefficient selection bitmap transmitted at 1014 may be transmitted in the CSI part 2 (e.g., in the coefficient selection bitmap field 518 in the CSI part 2 504, as shown in FIG. 5).

In some aspects, each subset may be a respective column in each time domain basis of the three-dimensional bitmap that is associated with a respective frequency domain basis, and an element associated with a respective time domain basis and a respective frequency domain basis in the second coefficient selection bitmap having a predetermined value indicates that all coefficients correspondingly indexed in the first coefficient selection bitmap are selected. For example, referring to FIG. 8, each subset is a respective column in each time domain basis (e.g., q=0, q=1, q=3, etc.) of the three-dimensional bitmap 802 that is associated with a respective frequency domain basis. An element associated with a respective time domain basis and a respective frequency domain basis in the second coefficient selection bitmap having a predetermined value (e.g., “1”) indicates that all coefficients correspondingly indexed in the first coefficient selection bitmap are selected. For instance, as shown in FIG. 8, the element located for time domain basis q=0 and frequency domain basis m=2 (i.e., the third column) in the second stage indication 808 is equal to “1”. Accordingly, all the coefficients in the corresponding third column of the first stage indication 804 are selected.

In some aspects, the second coefficient selection bitmap may be associated with the frequency domain and a time domain. For example, referring to FIG. 10, the second coefficient selection bitmap transmitted at 1014 may be associated with the frequency domain and a time domain. In the example shown in FIG. 8, the second coefficient selection bitmap may be the second stage indication 808, which is associated with the frequency domain and a time domain.

In some aspects, each subset may be a respective row in each time domain basis of the three-dimensional bitmap that is associated with a respective spatial domain basis, and an element associated with a respective time domain basis and a respective spatial domain basis in the second coefficient selection bitmap having a predetermined value indicates that all coefficients correspondingly indexed in the first coefficient selection bitmap are selected. For example, referring to FIG. 8, each subset is a respective row in each time domain basis (e.g., q=0, q=1, q=3, etc.) of the three-dimensional bitmap 802 that is associated with a respective frequency spatial basis. An element associated with a respective time domain basis and a respective spatial domain basis in the second coefficient selection bitmap having a predetermined value (e.g., “1”) indicates that all coefficients correspondingly indexed in the first coefficient selection bitmap are selected. For instance, as shown in FIG. 8, the element located for time domain basis q=0 and spatial domain basis/=4 (i.e., the fifth column) of the second stage indication 812 is equal to “1”. Accordingly, all the coefficients in the corresponding fifth row of the first stage indication 804 are selected.

In some aspects, the second coefficient selection bitmap may be associated with the spatial domain and the time domain. For example, referring to FIG. 10, the second coefficient selection bitmap transmitted at 1014 may be associated with the spatial domain and the time domain. In the example shown in FIG. 8, the second coefficient selection bitmap may be the second stage indication 812, which is associated with the spatial domain and the time domain.

In some aspects, communication with precoding based on the first coefficient selection bitmap and the second coefficient selection bitmap may be received. For example, referring to FIG. 10, at 1018, the UE may receive communication with precoding based on the first coefficient selection bitmap and the second coefficient selection bitmap from the network node 1004.

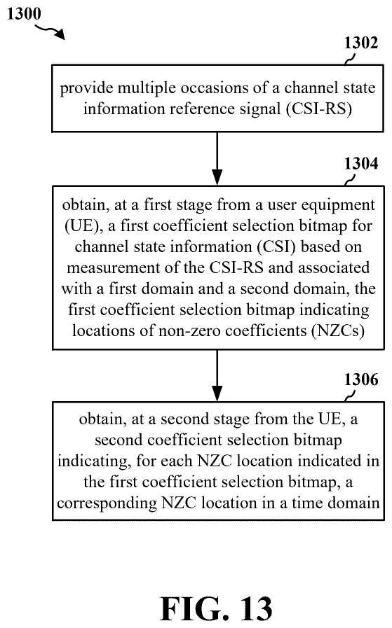

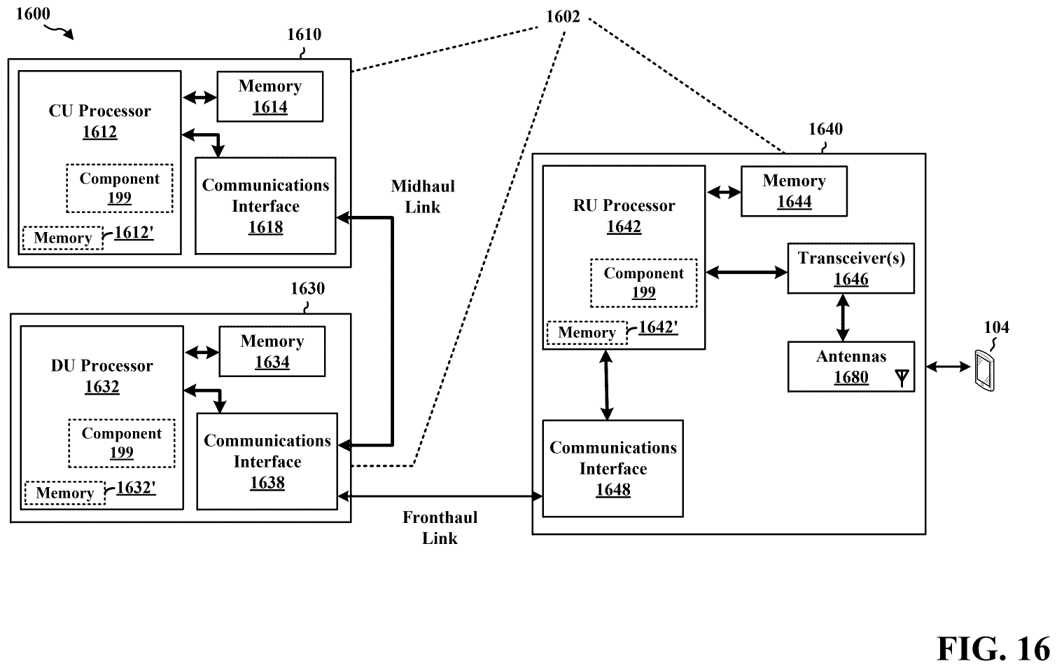

FIG. 13 is a flowchart 1300 illustrating methods of wireless communication at a network node in accordance with various aspects of the present disclosure. The method may be performed by a network node. The network node may be a base station, or a component of a base station, in the access network of FIG. 1 or a core network component (e.g., base station 102, 310; the CU 110; the DU 130; the RU 140; network node 1004; or the network entity 1602 in the hardware implementation of FIG. 16).

As shown in FIG. 13, at 1302, the network node may provide multiple occasions of CSI-RS. For example, referring to FIG. 10, the network node 1004 may provide multiple occasions of CSI-RS to the UE 1002.

At 1304, at a first stage, a first coefficient selection bitmap for CSI based on measurement of the CSI-RS and associated with a first domain and a second domain may be obtained, the first coefficient selection bitmap indicating locations for NZCs. For example, referring to FIG. 10, the UE 1002 may generate the first coefficient selection bitmap for CSI based on measurement of the CSI-RS at 1008, and the network node 1004 may obtain the first coefficient selection bitmap at 1010. As described above with reference to FIG. 8, the network node may obtain the first coefficient selection bitmap (e.g., 804) at the first stage.

In some aspects, the first domain may be a frequency domain, and the second domain may be a spatial domain. For example, referring to FIG. 10, the first coefficient selection bitmap obtained at 1010 by the network node 1004 may be associated with the frequency domain and the spatial domain.

In some aspects, the first coefficient selection bitmap may be obtained in a first CSI part included in UCI. For example, referring to FIG. 10, the first coefficient selection bitmap obtained at 1010 by the network node 1004 may be obtained in the CSI part 1 (e.g., the CSI part 1 502 or 902, as respectively shown in FIGS. 5 and 9) included in UCI.

At 1306, at a second stage, a second coefficient selection bitmap indicating, for each NZC location indicated in the first coefficient selection bitmap, a corresponding NZC location in a time domain may be obtained. For example, referring to FIG. 10, the UE 1002 may generate, at 1012, the second coefficient selection bitmap indicating, for each NZC location indicated in the first coefficient selection bitmap, a corresponding NZC location in a time domain, and the network node 1004 may obtain the second coefficient selection bitmap at 1014.

In some aspects, the second coefficient selection bitmap may be obtained in a second CSI part included in the UCI. For example, referring to FIG. 10, the second coefficient selection bitmap obtained at 1014 at the network node 1004 may be obtained in the CSI part 2 (e.g., in the coefficient selection bitmap field 518 in the CSI part 2 504, as shown in FIG. 5).

In some aspects, communication with the UE may be precoding based on the first coefficient selection bitmap and the second coefficient selection bitmap. For example, referring to FIG. 10, at 1016, the network node 1004 may precode communication with the UE 1002 based on the first coefficient selection bitmap and the second coefficient selection bitmap.

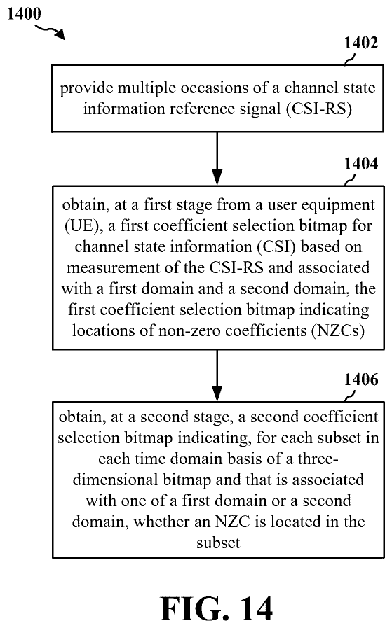

FIG. 14 is a flowchart 1400 illustrating methods of wireless communication at a network node in accordance with various aspects of the present disclosure. The method may be performed by a network node. The network node may be a base station, or a component of a base station, in the access network of FIG. 1 or a core network component (e.g., base station 102, 310; the CU 110; the DU 130; the RU 140; network node 1004; or the network entity 1602 in the hardware implementation of FIG. 16).

As shown in FIG. 14, at 1402, the network node may provide multiple occasions of CSI-RS. For example, referring to FIG. 10, the network node 1004 may provide multiple occasions of CSI-RS to the UE 1002.

At 1404, at a first stage, a first coefficient selection bitmap for CSI based on measurement of the CSI-RS and associated with a first domain and a second domain may be obtained, the first coefficient selection bitmap indicating locations for NZCs. For example, referring to FIG. 10, the UE 1002 may generate the first coefficient selection bitmap for CSI based on measurement of the CSI-RS at 1008, and the network node 1004 may obtain the first coefficient selection bitmap at 1010. As described above with reference to FIG. 8, the network node may obtain the first coefficient selection bitmap (e.g., 804) at the first stage.

In some aspects, the first domain may be a frequency domain, and the second domain may be a spatial domain. For example, referring to FIG. 10, the first coefficient selection bitmap obtained at 1010 by the network node 1004 may be associated with the frequency domain and the spatial domain.

In some aspects, the first coefficient selection bitmap may be obtained in a first CSI part included in UCI. For example, referring to FIG. 10, the first coefficient selection bitmap obtained at 1010 by the network node 1004 may be obtained in the CSI part 1 (e.g., the CSI part 1 502 or 902, as respectively shown in FIGS. 5 and 9) included in UCI.

At 1406, at a second stage, a second coefficient selection bitmap indicating, for each subset in each time domain basis of a three-dimensional bitmap and that is associated with one of a first domain or a second domain, whether an NZC is located in the subset may be obtained. For example, referring to FIG. 10, the UE 1002 may generate, at 1012, the second coefficient selection bitmap indicating, for each subset in each time domain basis of a three-dimensional bitmap and that is associated with one of a first domain or a second domain, whether an NZC is located in the subset, and the network node 1004 may obtain the second coefficient selection bitmap at 1014.

In some aspects, the second coefficient selection bitmap may be obtained in a second CSI part included in the UCI. For example, referring to FIG. 10, the second coefficient selection bitmap obtained at 1014 at the network node 1004 may be obtained in the CSI part 2 (e.g., in the coefficient selection bitmap field 518 in the CSI part 2 504, as shown in FIG. 5).

In some aspects, each subset may be a respective column in each time domain basis of the three-dimensional bitmap that is associated with a respective frequency domain basis. For example, referring to FIG. 8, each subset is a respective column in each time domain basis (e.g., q=0, q=1, q=3, etc.) of the three-dimensional bitmap 802 that is associated with a respective frequency domain basis.

In some aspects, the second coefficient selection bitmap may be associated with the frequency domain and a time domain. For example, referring to FIG. 10, the second coefficient selection bitmap obtained at 1014 may be associated with the frequency domain and a time domain. In the example shown in FIG. 8, the second coefficient selection bitmap may be the second stage indication 808, which is associated with the frequency domain and a time domain.

In some aspects, each subset may be a respective row in each time domain basis of the three-dimensional bitmap that is associated with a respective spatial domain basis. For example, referring to FIG. 8, each subset is a respective row in each time domain basis (e.g., q=0, q=1, q=3, etc.) of the three-dimensional bitmap 802 that is associated with a respective frequency spatial basis.

In some aspects, the second coefficient selection bitmap may be associated with the spatial domain and the time domain. For example, referring to FIG. 10, the second coefficient selection bitmap obtained at 1014 may be associated with the spatial domain and the time domain. In the example shown in FIG. 8, the second coefficient selection bitmap may be the second stage indication 812, which is associated with the spatial domain and the time domain.

In some aspects, communication with the UE may be precoding based on the first coefficient selection bitmap and the second coefficient selection bitmap. For example, referring to FIG. 10, at 1016, the network node 1004 may precode communication with the UE 1002 based on the first coefficient selection bitmap and the second coefficient selection bitmap.

FIG. 15 is a diagram 1500 illustrating an example of a hardware implementation for an apparatus 1504. The apparatus 1504 may be a UE, a component of a UE, or may implement UE functionality. In some aspects, the apparatus1504 may include a cellular baseband processor 1524 (also referred to as a modem) coupled to one or more transceivers 1522 (e.g., cellular RF transceiver). The cellular baseband processor 1524 may include on-chip memory 1524′. In some aspects, the apparatus 1504 may further include one or more subscriber identity modules (SIM) cards 1520 and an application processor 1506 coupled to a secure digital (SD) card 1508 and a screen 1510. The application processor 1506 may include on-chip memory 1506′. In some aspects, the apparatus 1504 may further include a Bluetooth module 1512, a WLAN module 1514, an SPS module 1516 (e.g., GNSS module), one or more sensor modules 1518 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1526, a power supply 1530, and/or a camera 1532. The Bluetooth module 1512, the WLAN module 1514, and the SPS module 1516 may include an on-chip transceiver (TRX) (or in some cases, just a receiver (RX)). The Bluetooth module 1512, the WLAN module 1514, and the SPS module 1516 may include their own dedicated antennas and/or utilize the antennas 1580 for communication. The cellular baseband processor 1524 communicates through the transceiver(s) 1522 via one or more antennas 1580 with the UE 104 and/or with an RU associated with a network entity 1502. The cellular baseband processor 1524 and the application processor 1506 may each include a computer-readable medium/memory 1524′, 1506′, respectively. The additional memory modules 1526 may also be considered a computer-readable medium/memory. Each computer-readable medium/memory 1524′, 1506′, 1526 may be non-transitory. The cellular baseband processor 1524 and the application processor 1506 are each responsible for general processing, including the execution of software stored on the computer-readable medium/memory. The software, when executed by the cellular baseband processor 1524/application processor 1506, causes the cellular baseband processor 1524/application processor 1506 to perform the various functions described supra. The computer-readable medium/memory may also be used for storing data that is manipulated by the cellular baseband processor 1524/application processor 1506 when executing software. The cellular baseband processor 1524/application processor 1506 may be a component of the UE 350 and may include the memory 360 and/or at least one of the TX processor 368, the RX processor 356, and the controller/processor 359. In one configuration, the apparatus 1504 may be a processor chip (modem and/or application) and include just the cellular baseband processor 1524 and/or the application processor 1506, and in another configuration, the apparatus 1504 may be the entire UE (e.g., see 350 of FIG. 3) and include the additional modules of the apparatus 1504.

As discussed supra, the component 198, in one configuration, is configured to measure multiple occasions of a CSI-RS, transmit, at a first stage, a first coefficient selection bitmap for CSI based on measurement of the CSI-RS and associated with a first domain and a second domain, the first coefficient selection bitmap indicating locations of NZCs, and transmit, at a second stage, a second coefficient selection bitmap indicating, for each NZC location indicated in the first coefficient selection bitmap, a corresponding NZC location in a time domain. In another configuration, the component 198 is configured to measure multiple occasions of a CSI-RS, transmit, at a first stage, a first coefficient selection bitmap for CSI based on measurement of the CSI-RS and associated with a first domain and a second domain, the first coefficient selection bitmap indicating locations of NZCs, and transmit, at a second stage, a second coefficient selection bitmap indicating, for each subset in each time domain basis of a three-dimensional bitmap and that is associated with one of a first domain or a second domain, whether an NZC is located in the subset. The component 198 may be further configured to perform any of the aspects described in connection with the flowchart in FIG. 11, FIG. 12, and/or the aspects performed by the UE in the communication flow in FIG. 10. The component 198 may be within the cellular baseband processor 1524, the application processor 1506, or both the cellular baseband processor 1524 and the application processor 1506. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1504 may include a variety of components configured for various functions. In one configuration, the apparatus 1504, and in particular the cellular baseband processor 1524 and/or the application processor 1506, includes means for measuring multiple occasions of a CSI-RS, means for transmitting, at a first stage, a first coefficient selection bitmap for CSI based on measurement of the CSI-RS and associated with a first domain and a second domain, the first coefficient selection bitmap indicating locations of NZCs, and means for transmitting, at a second stage, a second coefficient selection bitmap indicating, for each NZC location indicated in the first coefficient selection bitmap, a corresponding NZC location in a time domain. In another configuration, the apparatus 1504, and in particular the cellular baseband processor 1524 and/or the application processor 1506, includes means for measuring multiple occasions of a CSI-RS, means for transmitting, at a first stage, a first coefficient selection bitmap for CSI based on measurement of the CSI-RS and associated with a first domain and a second domain, the first coefficient selection bitmap indicating locations of NZCs, and means for transmitting, at a second stage, transmitting, at a second stage, a second coefficient selection bitmap indicating, for each subset in each time domain basis of a three-dimensional bitmap and that is associated with one of a first domain or a second domain, whether an NZC is located in the subset. The apparatus may further include means for performing any of the aspects described in connection with the flowchart in FIG. 11, FIG. 12, and/or the aspects performed by the UE in the communication flow in FIG. 10. The means may be the component 198 of the apparatus 1504 configured to perform the functions recited by the means. As described supra, the apparatus 1504 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 16 is a diagram 1600 illustrating an example of a hardware implementation for a network entity 1602. The network entity 1602 may be a BS, a component of a BS, or may implement BS functionality. The network entity 1602 may include at least one of a CU 1610, a DU 1630, or an RU 1640. For example, depending on the layer functionality handled by the component 199, the network entity 1602 may include the CU 1610; both the CU 1610 and the DU 1630; each of the CU 1610, the DU 1630, and the RU 1640; the DU 1630; both the DU 1630 and the RU 1640; or the RU 1640. The CU 1610 may include a CU processor 1612. The CU processor 1612 may include on-chip memory 1612′. In some aspects, the CU 1610 may further include additional memory modules 1614 and a communications interface 1618. The CU 1610 communicates with the DU 1630 through a midhaul link, such as an F1 interface. The DU 1630 may include a DU processor 1632. The DU processor 1632 may include on-chip memory 1632′. In some aspects, the DU 1630 may further include additional memory modules 1634 and a communications interface 1638. The DU 1630 communicates with the RU 1640 through a fronthaul link. The RU 1640 may include an RU processor 1642. The RU processor 1642 may include on-chip memory 1642′. In some aspects, the RU 1640 may further include additional memory modules 1644, one or more transceivers 1646, antennas 1680, and a communications interface 1648. The RU 1640 communicates with the UE 104. The on-chip memory 1612′, 1632′, 1642′ and the additional memory modules 1614, 1634, 1644 may each be considered a computer-readable medium/memory. Each computer-readable medium/memory may be non-transitory. Each of the processors 1612, 1632, 1642 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, in one configuration, the component 199 is configured to provide multiple occasions of a CSI-RS, obtain, at a first stage from a UE, a first coefficient selection bitmap for CSI based on measurement of the CSI-RS and associated with a first domain and a second domain, the first coefficient selection bitmap indicating locations of NZCs, and obtain, at a second stage from the UE, a second coefficient selection bitmap indicating, for each NZC location indicated in the first coefficient selection bitmap, a corresponding NZC location in a time domain. In another configuration, the component 199 is configured to provide multiple occasions of a CSI-RS, obtain, at a first stage from a UE, a first coefficient selection bitmap for CSI based on measurement of the CSI-RS and associated with a first domain and a second domain, the first coefficient selection bitmap indicating locations of NZCs, and obtain, at a second stage, a second coefficient selection bitmap indicating, for each subset in each time domain basis of a three-dimensional bitmap and that is associated with one of a first domain or a second domain, whether an NZC is located in the subset. The component 199 may be further configured to perform any of the aspects described in connection with the flowchart in FIG. 13, FIG. 14, and/or the aspects performed by the network node in the communication flow in FIG. 10. The component 199 may be within one or more processors of one or more of the CU 1610, DU 1630, and the RU 1640. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1602 may include a variety of components configured for various functions. In one configuration, the network entity 1602 includes means for providing multiple occasions of a CSI-RS, means for obtaining, at a first stage from a UE, a first coefficient selection bitmap for CSI based on measurement of the CSI-RS and associated with a first domain and a second domain, the first coefficient selection bitmap indicating locations of NZCs, and means for obtaining, at a second stage from the UE, a second coefficient selection bitmap indicating, for each NZC location indicated in the first coefficient selection bitmap, a corresponding NZC location in a time domain. In another configuration, the network entity 1602 includes means for providing multiple occasions of a CSI-RS, means for obtaining, at a first stage from a UE, a first coefficient selection bitmap for CSI based on measurement of the CSI-RS and associated with a first domain and a second domain, the first coefficient selection bitmap indicating locations of NZCs, and means for obtaining, at a second stage, a second coefficient selection bitmap indicating, for each subset in each time domain basis of a three-dimensional bitmap and that is associated with one of a first domain or a second domain, whether an NZC is located in the subset. The network entity may further include means for performing any of the aspects described in connection with the flowchart in FIG. 13, FIG. 14, and/or the aspects performed by the network node in the communication flow in FIG. 10. The means may be the component 199 of the network entity 1602 configured to perform the functions recited by the means. As described supra, the network entity 1602 may include the TX processor 316, the RX processor 370, and the controller/processor 375. As such, in one configuration, the means may be the TX processor 316, the RX processor 370, and/or the controller/processor 375 configured to perform the functions recited by the means.

This disclosure provides methods and apparatus that exploit the channel sparsity in SD&FD&TD (e.g., a three-dimensional bitmap) to reduce bitmap overhead. As such, the present disclosure provides for methods and apparatus for reducing a NZC selection bitmap for time domain (TD) CSI. For example, the methods and apparatus provide a CSI reporting enhancement for high/medium UE velocities by exploiting time-domain correlation/Doppler-domain information to assist DL precoding, for example, targeting FR1. The UE may report time-domain channel properties measured via CSI-RS for tracking purposes. The methods and apparatus advantageously enable extrapolation for channel prediction and reduces reporting overhead.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, the method including measuring multiple occasions of a CSI-RS, transmitting, at a first stage, a first coefficient selection bitmap for CSI based on measurement of the CSI-RS and associated with a first domain and a second domain, the first coefficient selection bitmap indicating locations of NZCs, and transmitting, at a second stage, a second coefficient selection bitmap indicating, for each NZC location indicated in the first coefficient selection bitmap, a corresponding NZC location in a time domain.

Aspect 2 is the method of aspect 1, wherein first domain comprises a spatial domain, and the second domain comprises a frequency domain.

Aspect 3 is the method of any of aspects 1 to 2, wherein the first coefficient selection bitmap is transmitted in a first CSI field included in an UCI.

Aspect 4 is the method of aspect 3, wherein the second coefficient selection bitmap is transmitted in a second CSI field included in the UCI.

Aspect 5 is the method of aspect 3, wherein a total number of NZ bits in the first coefficient selection bitmap is reported in a first CSI part.

Aspect 6 is the method of aspect 5, wherein the total number of NZ bits is used for reporting the second coefficient selection bitmap in a second CSI part.

Aspect 7 is the method of any of aspects 1 to 6, further including receiving communication with precoding based on the first coefficient selection bitmap and the second coefficient selection bitmap.

Aspect 8 is the method of any of aspects 1, 2 and 7, wherein the first coefficient selection bitmap and the second coefficient selection bitmap are transmitted in a second CSI part included in an uplink control information (UCI), and wherein the second CSI part is transmitted subsequent to a first CSI part in the UCI.

Aspect 9 is the method of aspect 8, wherein a number of bits no smaller than a total number of NZ bits in the first coefficient selection bitmap is reserved in a CSI part for reporting the second coefficient selection bitmap.

Aspect 10 is the method of aspect 2, wherein a maximum number of NZ bits associated with the first coefficient selection bitmap and the second coefficient selection bitmap is based on: a scaling parameter associated with the frequency domain, the spatial domain, and the time domain; a number of beams utilized for transmission; a number of selected frequency domain basis associated with a first rank; and a number of selected Doppler basis.

Aspect 11 is the method of aspect 2, wherein a maximum number of NZ bits associated with the first coefficient selection bitmap and the second coefficient selection bitmap is based on at least: a first scaling parameter; a second scaling parameter associated with the time domain; a number of beams utilized for transmission; a number of selected frequency domain basis associated with a first rank; and a number of selected Doppler basis.

Aspect 12 is the method of aspect 11, wherein the maximum number of NZ bits is defined per-time domain-basis or a union of the per-time domain-basis.

Aspect 13 is a method of wireless communication at a UE, the method including measuring multiple occasions of a CSI-RS, transmitting, at a first stage, a first coefficient selection bitmap for CSI based on measurement of the CSI-RS and associated with a first domain and a second domain, the first coefficient selection bitmap indicating locations of NZCs, and transmitting, at a second stage, a second coefficient selection bitmap indicating, for each subset in each time domain basis of a three-dimensional bitmap and that is associated with one of a first domain or a second domain, whether an NZC is located in the subset.

Aspect 14 is a method of aspect 13, wherein the first domain is a frequency domain, and the second domain is a spatial domain.

Aspect 15 is a method of aspect 14, wherein the second coefficient selection bitmap is associated with the frequency domain and a time domain.

Aspect 16 is a method of aspect 15, wherein each subset is a respective column in each time domain basis of the three-dimensional bitmap that is associated with a respective frequency domain basis, and wherein an element associated with a respective time domain basis and a respective frequency domain basis in the second coefficient selection bitmap having a predetermined value indicates that all coefficients correspondingly indexed in the first coefficient selection bitmap are selected.

Aspect 17 is the method of aspect 14, wherein the second coefficient selection bitmap is associated with the spatial domain and a time domain.

Aspect 18 is the method of aspect 17, wherein each subset is a respective row in each time domain basis of the three-dimensional bitmap that is associated with a respective spatial domain basis, and wherein an element associated with a respective time domain basis and a respective spatial domain basis in the second coefficient selection bitmap having a predetermined value indicates that all coefficients correspondingly indexed in the first coefficient selection bitmap are selected.

Aspect 19 is a method of any of aspects 13 to 18, wherein the first coefficient selection bitmap is transmitted in a first CSI field included in an UCI.

Aspect 20 is a method of any of aspects 13 to 19, wherein the second coefficient selection bitmap is transmitted in a second CSI field included in the UCI.

Aspect 21 is a method of any of aspects 13 to 20, further including receiving communication with precoding based on the first coefficient selection bitmap and the second coefficient selection bitmap.

Aspect 22 is a method for wireless communication at a network node. The method includes providing multiple occasions of a CSI-RS, obtaining, at a first stage from a UE, a first coefficient selection bitmap for CSI based on measurement of the CSI-RS and associated with a first domain and a second domain, the first coefficient selection bitmap indicating locations of NZCs, and obtaining, at a second stage from the UE, a second coefficient selection bitmap indicating, for each NZC location indicated in the first coefficient selection bitmap, a corresponding NZC location in a time domain.

Aspect 23 is a method of aspect 22, wherein the first domain is a frequency domain, and the second domain is a spatial domain.

Aspect 24 is a method of any of aspects 22 to 23, wherein the first coefficient selection bitmap is obtained in a first CSI field included in an UCI.

Aspect 25 is a method of aspect 24, wherein the second coefficient selection bitmap is obtained in a second CSI field included in the UCI.

Aspect 26 is a method of any of aspects 22 to 25, further including precoding communication with the UE based on the first coefficient selection bitmap and the second coefficient selection bitmap

Aspect 27 is a method for wireless communication at a network node. The method includes providing multiple occasions of a CSI-RS, obtaining, at a first stage from a UE, a first coefficient selection bitmap for CSI based on measurement of the CSI-RS and associated with a first domain and a second domain, the first coefficient selection bitmap indicating locations of non-zero coefficients (NZCs), and obtaining, at a second stage, a second coefficient selection bitmap indicating, for each subset in each time domain basis of a three-dimensional bitmap and that is associated with one of a first domain or a second domain, whether an NZC is located in the subset.

Aspect 28 is a method of aspect 27, wherein the first domain is a frequency domain, and the second domain is a spatial domain.

Aspect 29 is a method of any of aspects 27 to 28, wherein each subset is a respective column in each time domain basis of the three-dimensional bitmap that is associated with a respective frequency domain basis.

Aspect 30 is a method of aspect 27 to 29, wherein the second coefficient selection bitmap is associated with the frequency domain and a time domain.

Aspect 31 is an apparatus for wireless communication at a UE. The apparatus includes memory; and at least one processor coupled to the memory and configured for implementing any of aspects 1 to 12.

Aspect 32 is an apparatus for wireless communication at a UE. The apparatus includes memory; and at least one processor coupled to the memory and configured for implementing any of aspects 13 to 21.

Aspect 33 is an apparatus for wireless communication at a network node. The apparatus includes memory; and at least one processor coupled to the memory and configured for implementing any of aspects 22 to 26.

Aspect 34 is an apparatus for wireless communication at a network node. The apparatus includes memory; and at least one processor coupled to the memory and configured for implementing any of aspects 27 to 30.

Aspect 35 is an apparatus for wireless communication including means for implementing any of aspects 1 to 12.

Aspect 36 is an apparatus for wireless communication including means for implementing any of aspects 13 to 21.

Aspect 37 is an apparatus for wireless communication including means for implementing any of aspects 22 to 26.

Aspect 38 is an apparatus for wireless communication including means for implementing any of aspects 27 to 30.

Aspect 39 is a computer-readable medium (e.g., a non-transitory computer-readable medium) storing computer executable code, the code when executed by at least one processor causes the at least one processor to implement any of aspects 1 to 12.

Aspect 40 is a computer-readable medium (e.g., a non-transitory computer-readable medium) storing computer executable code, the code when executed by at least one processor causes the at least one processor to implement any of aspects 13 to 21.

Aspect 41 is a computer-readable medium (e.g., a non-transitory computer-readable medium) storing computer executable code, the code when executed by at least one processor causes the at least one processor to implement any of aspects 22 to 26.

Aspect 42 is a computer-readable medium (e.g., a non-transitory computer-readable medium) storing computer executable code, the code when executed by at least one processor causes the at least one processor to implement any of aspects 27 to 30.

1. An apparatus for wireless communication at a user equipment (UE), comprising memory; and
at least one processor coupled to the memory and configured to:
measure multiple occasions of a channel state information reference signal (CSI-RS);
transmit, at a first stage, a first coefficient selection bitmap for channel state information (CSI) based on measurement of the CSI-RS and associated with a first domain and a second domain, the first coefficient selection bitmap indicating locations of non-zero coefficients (NZCs); and
transmit, at a second stage, a second coefficient selection bitmap indicating, for each NZC location indicated in the first coefficient selection bitmap, a corresponding NZC location in a time domain.

2. The apparatus of claim 1, wherein the first domain comprises a spatial domain, and the second domain comprises a frequency domain.

3. The apparatus of claim 1, wherein the first coefficient selection bitmap is transmitted in a first CSI field included in an uplink control information (UCI).

4. The apparatus of claim 3, wherein the second coefficient selection bitmap is transmitted in a second CSI field included in the UCI.

5. The apparatus of claim 3, wherein a total number of NZ bits in the first coefficient selection bitmap is reported in a first CSI part.

6. The apparatus of claim 5, wherein the total number of NZ bits is used for reporting the second coefficient selection bitmap in a second CSI part.

7. The apparatus of claim 1, further comprising:
receive communication with precoding based on the first coefficient selection bitmap and the second coefficient selection bitmap.

8. The apparatus of claim 1, wherein the first coefficient selection bitmap and the second coefficient selection bitmap are transmitted in a second CSI part included in an uplink control information (UCI), and wherein the second CSI part is transmitted subsequent to a first CSI part in the UCI.

9. The apparatus of claim 8, wherein a number of bits no smaller than a total number of NZ bits in the first coefficient selection bitmap is reserved in a CSI field for reporting the second coefficient selection bitmap.

10. The apparatus of claim 2, wherein a maximum number of NZ bits associated with the first coefficient selection bitmap and the second coefficient selection bitmap is based on:
a scaling parameter associated with the frequency domain, the spatial domain, and the time domain;
a number of beams utilized for transmission;
a number of selected frequency domain basis associated with a first rank; and
a number of selected Doppler basis.

11. The apparatus of claim 2, wherein a maximum number of NZ bits associated with the first coefficient selection bitmap and the second coefficient selection bitmap is based on at least:
a first scaling parameter;
a second scaling parameter associated with the time domain;
a number of beams utilized for transmission;
a number of selected frequency domain basis associated with a first rank; and
a number of selected Doppler basis.

12. The apparatus of claim 11, wherein the maximum number of NZ bits is defined per-time domain-basis or a union of the per-time domain-basis.

13. An apparatus for wireless communication at a user equipment (UE), comprising:
memory; and
at least one processor coupled to the memory and configured to:
measure multiple occasions of a channel state information reference signal (CSI-RS);
transmit, at a first stage, a first coefficient selection bitmap for channel state information (CSI) based on measurement of the CSI-RS and associated with a first domain and a second domain, the first coefficient selection bitmap indicating locations of non-zero coefficients (NZCs); and
transmit, at a second stage, a second coefficient selection bitmap indicating for each subset in each time domain basis of a three-dimensional bitmap and that is associated with one of the first domain or the second domain, whether an NZC is located in the subset.

14. The apparatus of claim 13, wherein the first domain is a frequency domain, and the second domain is a spatial domain.

15. The apparatus of claim 14, wherein the second coefficient selection bitmap is associated with the frequency domain and a time domain.

16. The apparatus of claim 15, wherein each subset is a respective column in each time domain basis of the three-dimensional bitmap that is associated with a respective frequency domain basis, and wherein an element associated with a respective time domain basis and a respective frequency domain basis in the second coefficient selection bitmap having a predetermined value indicates that all coefficients correspondingly indexed in the first coefficient selection bitmap are selected.

17. The apparatus of claim 14, wherein the second coefficient selection bitmap is associated with the spatial domain and a time domain.

18. The apparatus of claim 17, wherein each subset is a respective row in each time domain basis of the three-dimensional bitmap that is associated with a respective spatial domain basis, and wherein an element associated with a respective time domain basis and a respective spatial domain basis in the second coefficient selection bitmap having a predetermined value indicates that all coefficients correspondingly indexed in the first coefficient selection bitmap are selected.

19. The apparatus of claim 13, wherein the first coefficient selection bitmap is transmitted in a first CSI field included in an uplink control information (UCI).

20-21. (canceled)

22. An apparatus for wireless communication at network node, comprising:
memory; and
at least one processor coupled to the memory and configured to:
provide multiple occasions of a channel state information reference signal (CSI-RS);
obtain, at a first stage from a user equipment (UE), a first coefficient selection bitmap for channel state information (CSI) based on measurement of the CSI-RS and associated with a first domain and a second domain, the first coefficient selection bitmap indicating locations of non-zero coefficients (NZCs); and
obtain, at a second stage from the UE, a second coefficient selection bitmap indicating, for each NZC location indicated in the first coefficient selection bitmap, a corresponding NZC location in a time domain.

23-30. (canceled)
